(19) United States
(12) Patent Application Publication
(10) Pub. No.: US 2020/0009912 A1
(43) Pub. Date: Jan. 9, 2020

(54) METHODS FOR TREATING INNER LINERS, INNER LINERS RESULTING THEREFROM AND TIRES CONTAINING SUCH INNER LINERS

(71) Applicant: Bridgestone Americas Tire Operations, LLC, Nashville, TN (US)

(72) Inventors: Kung-Ching Liao, Copley, OH (US); Jared J. Griebel, Orange City, OH (US); Brian S. Alexander, Westfield, IN (US); Bradley S. Plotner, Akron, OH (US); Ross W. Widenor, Munroe Falls, OH (US)

(21) Appl. No.: 16/310,708

(22) PCT Filed: Jun. 27, 2017
(86) PCT No.: PCT/US2017/039516

§ 371 Date: Dec. 17, 2018

Related U.S. Application Data
(60) Provisional application No. 62/355,568, filed on Jun. 28, 2016.

(51) Int. Cl. B60C 1/00; B29D 30/06; C08F 210/12; C08F 236/14; C08L 83/04; C08G 8/30; C08F 210/02; C08L 7/00

(52) U.S. Cl. CPC B60C 1/0008; B29D 30/0681; C08F 210/12; C08F 236/14; B29D 2030/0682; C08G 8/30; C08F 210/02; C08L 7/00; C08L 83/04

(57) ABSTRACT

Methods for treating a cured inner liner as well as treated, cured inner liners resulting from such methods are disclosed. Also disclosed are tires containing the treated inner liners. The methods include treatment of the lower surface of inner liner surface with a rubber-containing liquid to produce a rubber-containing film thereupon.

### FIELD

The present application is directed to methods for treating the surface of a cured inner liner; to treated, cured inner liners resulting from such methods; and to tires containing the treated inner liners.

### BACKGROUND

When an uncured tire is placed into a tire mold for curing, the radially innermost component of the tire is often the inner liner. During the curing process that takes place in the tire mold, a bladder is inflated and presses against the radially inward-facing surface of the inner liner (the lower surface of the inner liner). In order to prevent sticking (or co-curing) of the lower surface of the inner liner to the bladder, a polysiloxane-containing release is often applied to the lower surface of inner liner (prior to the tire body being placed into the tire mold). While the polysiloxane-containing release provides the advantage of preventing sticking of the inner liner surface to the bladder in the tire mold during curing, it is disadvantageous after the cured tire is removed from the mold because it remains upon the lower surface of the cured inner liner (as part of the rubber) and inhibits adhesion of other materials to the lower surface.

### SUMMARY

Disclosed herein are methods for treating the surface of a cured inner liner; treated, cured inner liners resulting from such methods; and tires containing the treated inner liners.

In a first embodiment, a method for treating a cured inner liner is disclosed. The method comprises: providing a cured inner liner comprising rubber, a majority of which comprises butyl rubber (optionally halogenated), wherein the cured inner liner has an upper and a lower surface with the lower surface further comprising polysiloxane moieties; treating the lower surface of the cured inner liner with a rubber-containing liquid wherein the rubber-containing liquid comprises at least one conjugated diene monomer-containing rubber and at least one solvent, and allowing the rubber-containing liquid to dry upon the treated lower surface of the cured inner liner, thereby producing a rubber-containing film upon the lower surface.

In a second embodiment, a treated, cured inner liner is disclosed.

In a third embodiment, a cured tire is disclosed. The cured tire comprises a cured inner liner comprising rubber, a majority of which comprises butyl rubber (optionally halogenated), wherein the cured inner liner has an upper surface and a lower surface with the lower surface positioned radially inward within the tire and the lower surface further comprises polysiloxane moieties and has a rubber-containing film thereupon, with the rubber-containing film having a thickness of about 0.1 to about 25 micrometers and comprising at least one conjugated diene monomer-containing rubber.

In a fourth embodiment, a cured tire comprising a tire body, a cured inner liner, and at least one component positioned radially inward of the cured inner liner is disclosed. According to the fourth embodiment, the cured inner liner comprises rubber, a majority of which comprises butyl rubber (optionally halogenated), wherein the cured inner liner has an upper surface and a lower surface with the lower surface positioned radially inward within the tire and the lower surface further comprises polysiloxane moieties and has a rubber-containing film thereupon. The rubber-containing film has a thickness of about 0.1 to about 25 micrometers and comprises at least one conjugated diene monomer-containing rubber. The at least one component radially inward of the cured inner list is adhered to the rubber-containing film of the lower surface of the inner liner.

### DETAILED DESCRIPTION

Disclosed herein are methods for treating the surface of a cured inner liner; treated, cured inner liners resulting from such methods; and tires containing the treated inner liners.

In a first embodiment, a method for treating a cured inner liner is disclosed. The method comprises: providing a cured inner liner comprising rubber, a majority of which comprises butyl rubber (optionally halogenated), wherein the cured inner liner has an upper and a lower surface with the lower surface further comprising polysiloxane moieties; treating the lower surface of the cured inner liner with a rubber-containing liquid wherein the rubber-containing liquid comprises at least one conjugated diene monomer-containing rubber and at least one solvent, and allowing the rubber-containing liquid to dry upon the treated lower surface of the cured inner liner, thereby producing a rubber-containing film upon the lower surface.

In a second embodiment, a treated, cured inner liner is disclosed.

In a third embodiment, a cured tire is disclosed. The cured tire comprises a cured inner liner comprising rubber, a majority of which comprises butyl rubber (optionally halogenated), wherein the cured inner liner has an upper surface and a lower surface with the lower surface positioned radially inward within the tire and the lower surface further comprises polysiloxane moieties and has a rubber-containing film thereupon, with the rubber-containing film having a thickness of about 0.1 to about 25 micrometers and comprising at least one conjugated diene monomer-containing rubber.

In a fourth embodiment, a cured tire comprising a tire body, a cured inner liner, and at least one component positioned radially inward of the cured inner liner is disclosed. According to the fourth embodiment, the cured inner liner comprises rubber, a majority of which comprises butyl rubber (optionally halogenated), wherein the cured inner liner has an upper surface and a lower surface with the lower surface positioned radially inward within the tire and the lower surface further comprises polysiloxane moieties and has a rubber-containing film thereupon. The rubber-containing film has a thickness of about 0.1 to about 25 micrometers and comprises at least one conjugated diene monomer-containing rubber. The at least one component radially inward of the cured inner list is adhered to the rubber-containing film of the lower surface of the inner liner.

### Definitions

The terminology as set forth herein is for description of the embodiments only and should not be construed as limiting the invention as a whole.

As used herein, the term “majority” means more than 50% (e.g., 50.5%, 51%, 60%, etc.) and may encompass 100%.

As used herein, the term “natural rubber” means naturally occurring rubber such as can be harvested from sources such as Hevea rubber trees and non-Hevea sources (e.g., guayule shrubs and dandelions such as TKS). In other words, the term “natural rubber” should be construed so as to exclude synthetic polyisoprene.

As used herein, the term “phr” means parts per one hundred parts rubber. In certain embodiments, the 100 parts rubber should be understood to refer to 100 parts of the at least one diene monomer-containing rubber. 100 parts of rubber may also be referred to as 100 phr. The amount of any low molecular weight polymer or oligomer (e.g., polybutene) used as a tackifier is not included in the 100 parts of rubber.

As used herein, the term “polyisoprene” means synthetic polyisoprene. In other words, the term is used to indicate a polymer that is manufactured from isoprene monomers, and should not be construed as including naturally occurring rubber (e.g., Hevea natural rubber, guayule-sourced natural rubber, or dandelion-sourced natural rubber). However, the term polyisoprene should be construed as including polyisoprenes manufactured from natural sources of isoprene monomer.

As used herein, the term “radially inward” is a relative term indicating that a component is positioned or arranged closer to or facing the inner portion of a tire, with the understanding that the road-contacting tread is generally the radially outermost portion of a tire. As a non-limiting example, body plies within a tire are positioned radially inward of the road-contacting tread of the tire.

### Treated, Cured Inner Liner

As discussed above, the method of the first embodiment disclosed herein includes treating the surface of a cured inner liner, more specifically the lower surface of the cured inner liner. Additionally, the second-fourth embodiments disclosed herein also pertain to a cured inner liner (and a tire comprising a cured inner liner) which comprises rubber, a majority by weight of which comprises butyl rubber (optionally halogenated) and has an upper surface and a lower surface with a rubber-containing film; in certain embodiments of the second-fourth embodiments, the rubber-containing film can be understood as resulting from a method according to the first embodiment disclosed herein. The cured inner liner refers to the cured version of an inner liner which generally is cured in a tire mold as part of the tire making process. The lower surface of the cured inner liner refers to the surface that will face radially inward when the inner liner is incorporated into a tire. According to the method of the first embodiment, the cured inner liner that is provided may be part of a tire and the lower surface of the inner liner (or cured inner liner) refers to the surface that will be radially inward facing when the inner liner is contained within a tire. As discussed in more detail infra, the method of the first embodiment produces a rubber-containing film upon the lower surface of the cured inner liner by applying a rubber-containing liquid and allowing it to dry. Similarly, the cured inner liner (and tire comprising a cured inner liner) according to the second-fourth embodiments disclosed herein also include a rubber-containing film upon the lower surface of the cured inner liner.

According to the first embodiment disclosed herein, the cured inner liner that has its lower surface treated with the rubber-containing liquid has had its lower surface pre-treated with a release treatment comprising polysiloxane-moieties. Thus, the cured inner liner that is provided for treatment with the rubber-containing liquid has a lower surface comprising polysiloxane moieties. Similarly, according to the second-fourth embodiments disclosed herein, the cured inner liner comprising rubber, a majority of which comprises butyl rubber (optionally halogenated), has a lower surface further comprising a release treatment comprising polysiloxane moieties. Such a release treatment allows for a tire body containing the release treatment upon the lower surface of its inner liner to be cured in a tire mold and pressed against a curing bladder without sticking or co-curing of the inner liner's lower surface to the curing bladder. As discussed in more detail below, treatment of the polysiloxane-containing lower surface of the inner liner with the rubber-containing liquid and drying of that rubber-containing liquid produces a rubber-containing film without adhesive properties. In other words, the rubber-containing film is non-adhesive. However, the rubber-containing film also has the property of being an adhesion film in that it is capable of having a separate adhesive (e.g., a PSA) adhered to it. Notably, the polysiloxane-containing lower surface of the inner liner prior to treatment with the rubber-containing liquid is a release surface and is not capable of having a separate adhesive (e.g., a PSA) adhere to it. However, the rubber-containing film produced by the method of the first embodiment as well as the rubber-containing film according to the second-fourth embodiments is capable of having a separate adhesive (e.g., a PSA) adhere to it and, thus, the method of the first embodiment can be understood as improving the adherability of the lower surface of the cured inner liner.

As used herein, a polysiloxane moiety refers to the structure I, as follows: —[Si—O]ₓ—. Thus, by referring to polysiloxane moieties is meant that x is an integer of at least 2. In certain embodiments of the first-fourth embodiments, the release treatment comprises polysiloxane moieties wherein x is an integer of at least 50. In certain embodiments of the first-fourth embodiments, the release treatment comprises polysiloxane moieties wherein x is an integer ranging from 2 to 400 (e.g., 2, 5, 10, 20, 30, 40, 50, 75, 100, 150, 200, 250, 300, 350, 400), including 2 to 350, 2 to 300, 2 to 250, 2 to 200, 2 to 150, 2 to 100, 2 to 75, 2 to 50, 5 to 350, 5 to 300, 5 to 250, 5 to 200, 5 to 150, 5 to 100, 5 to 75, 5 to 50, 10 to 350, 10 to 300, 10 to 250, 10 to 200, 10 to 150, 10 to 100, 10 to 75, 10 to 50, 50 to 400, 50 to 350, 50 to 300, 50 to 250, or 50 to 200. As those of skill in the art will appreciate, each Si in structure I is capable of forming four bonds in total and, thus, each intermediary Si (e.g., when x=4 this would be the 2^{nd} and 3^{rd} Si) is bonded to two hydrocarbyl groups and each terminal Si (e.g., when x=4 this would be the 1^{st} and 4^{th} Si) is bonded to two hydrocarbyl groups and one additional terminal group. Such polysiloxanes can be referred to as diorganopolysiloxanes. Notably, according to certain embodiments of the first-fourth embodiments, the two “organo” groups to which each intermediary Si is bonded need not be the same and each intermediary Si need not be bonded to the same two organo groups or the same combination of two organo groups. In certain embodiments of the first-fourth embodiments, the hydrocarbyl groups to which each intermediary Si is bonded comprise a methyl group; such a polysiloxane can be referred to as polydimethylsiloxane. Other exemplary polysiloxanes for use in effecting a release property to the lower surface of the inner liner during tire molding include, but are not limited to, dialkylpolysiloxanes such as diethylpolysiloxane, methylisopropylpolysiloxane, and methyldodecylpolysiloxane; diarylpolysiloxanes such as diphenylpolysiloxane; alkylphenylpolysiloxanes such as methylphenylpolysiloxane, dimethylsiloxane-methylphenylsilaxane copolymers, and dirnethylsiloxane-diphenylsiloxane copolymers; alkylaralkylpolysiloxanes such as methyl(phenylethyl)polysiloxane and methyl(phenylpropyl)polysiloxane; and 3,3,3-trifluoropropylmethylpolysiloxane; in certain embodiments of the first-fourth embodiments, the release treatment comprises one or more of the foregoing polysiloxanes. The two organo groups on the intermediary Si and on the terminal Si of the polysiloxane may be independently selected from linear or branched alkyl having C1-C8, optionally substituted with at least one halogen (e.g., fluorine), and cycloalkyl having C3-C8. In certain embodiments of the first-fourth embodiments, each terminal Si of the polysiloxane chain is endblocked by a hydroxyl group, a hydrocarbyl group or an alkoxy group.

According to the first-fourth embodiments, the cured inner liner having a rubber-containing film upon its lower surface (as well as the cured inner liner which is treated with the rubber-containing liquid) comprises rubber, a majority by weight of which butyl rubber which is optionally halogenated. (Unless indicated to the contrary, the following discussion concerning rubber(s), filler(s) and other ingredients of the cured inner liner applies equally to the cured inner liner having a rubber-containing film upon its lower surface and to the cured inner liner which is treated with the rubber-containing liquid.) Moreover, the following discussion should also be understood as applying to the composition of the cured inner liner but not the rubber-containing film that is produced therein (as the composition of the rubber-containing film is discussed in detail in a separate section). In other words, the cured inner liner comprises rubber, and a majority by weight of the rubber of such inner liner comprises one or more butyl rubbers and each of those butyl rubbers is optionally halogenated. (As discussed below, in certain embodiments of the first-fourth embodiments, the cured inner liner further comprises one or more fillers and optionally one or more curatives mixed with the optionally halogenated butyl rubber(s).) Butyl rubber is a copolymer of isobutylene and a small amount of a diene-based monomer, typically isoprene or para-methylstyrene. The polymer chains of butyl rubber therefore typically have a highly saturated backbone. Butyl rubber typically contains more than about 90% isobutylene and less than about 10% diene-based monomer (e.g., isoprene or para-methylstyrene) by weight in the copolymer, including about 90-99.5% isobutylene and about 10 to about 0.5% diene-based monomer, about 95-99.5% isobutylene and about 5-0.5% diene-based monomer, about 96-99% isobutylene and about 4-1% diene-based monomer, about 97-98.5% isobutylene and about 1.5-3% diene-based monomer, and including about 98% isobutylene and about 2% diene-based monomer by weight in the copolymer. Typically, the diene-based mer (e.g., isoprenyl or para-methylstyrenyl) units are distributed randomly in the polymer chains of butyl rubber. Non-limiting examples of suitable polymers for use as the at least one butyl rubber or a halogenated butyl rubber of the cured inner liner according to certain embodiments of the first-fourth embodiments disclosed herein include, but are not limited to, butyl rubber, chlorobutyl rubber, bromobutyl rubber, fluorobutyl rubber, iodobutyl rubber, copolymers thereof, and combinations thereof. In certain embodiments of the first-fourth embodiments, the cured inner liner comprises bromobutyl rubber. In certain embodiments of the first-fourth embodiments, the only rubber present in the cured inner liner (excepting the rubber-containing film) is bromobutyl rubber (i.e., of 100 parts or 100 phr of rubber present in the cured inner liner all 100 parts or 100 phr is bromobutyl rubber).

In certain embodiments of the first-fourth embodiments disclosed herein, the cured inner liner comprises other ingredients in addition to the optionally halogenated butyl rubber(s). These other ingredients of the cured inner liner may vary but will generally include one or more fillers (e.g., carbon black, clay or silica) and a cure package (e.g., a vulcanizing agent such as sulfur and one or more vulcanization accelerators). In certain embodiments of the first-fourth embodiments disclosed herein, the cured inner liner comprises one or more butyl rubbers (optionally halogenated) and 10-100 phr (including 20-80 phr, 30-70 phr, 15 phr, 20 phr, 30 phr, 40 phr, 50 phr, 60 phr, 70 phr, 80 phr, 90 phr, etc.) of one or more of the foregoing fillers. In certain embodiments of the first-fourth embodiments, the rubber of the cured inner liner comprises at least 60% by weight (e.g., 60%, 65%, 70%, 75%, 80%, 85%, 90%, 95% or 100% by weight) of at least one of: a butyl rubber or halogenated butyl rubber (or a combination thereof, as discussed above). In certain embodiments of the first-fourth embodiments, the rubber of the cured inner liner comprises at least one of the following rubbers in addition to the butyl or halogenated butyl rubber(s): natural rubber, polyisoprene, styrene-butadiene rubber, isoprene rubber, polybutadiene rubber, nitrile rubber (acrylonitrile-butadiene copolymers), or hydrogenated nitrile rubber.

The thickness of the cured inner liner utilized in or included within the first-fourth embodiments may vary. In certain embodiments of the first-fourth embodiments, the cured inner liner has a thickness of 0.5-2 mm. Since the thickness of the rubber-containing film is relatively small in comparison (as discussed further below), a thickness of 0.5-2 mm (to one or two significant digits) can be understood as applying to both the cured inner liner without the rubber-containing film as well as the cured inner liner with rubber-containing film upon its lower surface.

### Rubber-Containing Liquid

As discussed above, according to the method of the first embodiment, the lower surface of the cured inner liner is treated with a rubber-containing liquid. The rubber-containing liquid comprises at least one conjugated diene monomer-containing rubber and at least one solvent. By liquid is meant that the composition is pourable or at least flowable at room temperature (i.e., 23° C.). According to the first embodiment, the viscosity of the rubber-containing liquid may vary. In certain embodiments of the first embodiment, the rubber-containing liquid has a viscosity at room temperature of no more than 5000 centipoise, about 5000 to about 1 centipoise (e.g., 5000, 4000, 3000, 2500, 2000, 1000, 750, 500, 250, 100, 50, 25, 1), 5000-1 centipoise, about 2500 to about 1 centipoise, 2500-1 centipoise, about 1000 to about 50 centipoise, or 1000-50 centipoise. In certain embodiments of the first embodiment wherein the majority by weight of the solvent present in the rubber-containing liquid comprises water, the viscosity of the rubber-containing liquid is about 50 to about 5000 centipoise (e.g., 50, 100, 250, 500, 1000, 1500, 2000, 2500, 3000, 3500, 4000, 4500 or 5000), 50-500 centipoise, about 100 to about 2500 centipoise, 100-2500 centipoise, about 100 to about 1000 centipoise, or 100-1000 centipoise. In certain embodiments of the first embodiment wherein a majority by weight of the solvent present in the rubber-containing liquid comprises at least one hydrocarbon solvent, the rubber-containing liquid has a viscosity at room temperature of no more than about 1000 centipoise, no more than 1000 centipoise, about 1000 to about 1 centipoise (e.g., 1000, 900, 800, 700, 600, 500, 400, 300, 200, 150, 100, 50, 25, 1), 1000-1 centipoise, about 500 to about 1 centipoise, 500-1 centipoise, about 500 to about 50 centipoise, 500-50 centipoise, about 500 to about 150 centipoise, or 500-150 centipoise. The viscosities referred to herein can be determined using a Brookfield model RVF viscometer with a #3 spindle at 10 rpm for higher viscosities (greater than 1000) and a #2 spindle at 20 rpm for lower viscosities (1000 and less).

In certain embodiments of the first embodiment, the rubber-containing liquid comprises about 5 to about 70% (e.g., 5%, 10%, 15%, 20%, 25%, 30%, 35%, 40%, 45%, 50%, 55%, 60%, 65%, 70%) by weight of the at least one conjugated diene monomer-containing rubber. When more than one conjugated diene monomer-containing rubber is used in the rubber-containing liquid, the values identified herein refer to the total amount of all conjugated diene monomer-containing rubbers. In certain embodiments of the first embodiment wherein a majority by weight of the solvent of the rubber-containing liquid comprises water, the relatively higher amounts of at least one conjugated diene-monomer containing rubber within the rubber-containing liquid may be preferred, e.g., about 25 to about 70% by weight (e.g., 25%, 30%, 35%, 40%, 45%, 50%, 55%, 60%, 65%, 70%). In certain embodiments of the first embodiment wherein a majority by weight of the solvent of the rubber-containing liquid comprises water, the rubber-containing liquid comprises an amount of at least one conjugated diene-monomer containing rubber of about 30 to about 70%, 30 to 70%, about 35 to about 70%, 35 to 70%, about 30 to about 65%, 30 to 65%, about 35 to about 65%, or 35 to 65% by weight. In certain embodiments of the first embodiment wherein a majority by weight of the solvent of the rubber-containing liquid comprises at least one hydrocarbon solvent, the relatively lower amounts of the at least one conjugated diene monomer-containing rubber may be preferred, e.g., about 5 to about 25%, 5 to 25%, about 8 to about 25%, 8 to 25%, about 5 to about 20%, 5 to 20%, about 8 to about 20%, about 10 to about 20%, or 10 to 20% by weight of the at least one conjugated diene-monomer containing rubber.

In certain embodiments of the first embodiment, the rubber-containing liquid has a solids content (i.e., based upon the total amount of conjugated diene-monomer containing rubber and any tackifier, filler, stabilizer/surfactant, antioxidant, or plasticizer) of about 10 to about 75% by weight (e.g., 10%, 15%, 20%, 25%, 30%, 35%, 40%, 45%, 50%, 55%, 60%, 65%, 70%, 75%). The solids content of the rubber-containing liquid is based upon components which will not evaporate or dry out of the rubber-containing liquid when forming the rubber-containing film, i.e., the at least one conjugated diene-monomer containing rubber as well as any tackifier, filler, antioxidant, plasticizer, or stabilizer/surfactant. When any of the foregoing “solid” materials are added to the rubber-containing liquid in a form which includes one or more solvents (e.g., rubber latex, filler dispersed in solvent), the solvent portion of that material is excluded from the solids content. As a non-limiting example, the addition of 10 phr of an aqueous dispersion of carbon black (containing 50% carbon black) would contribute 5 phr of solids to the rubber-containing liquid. In certain embodiments of the first embodiment wherein a majority by weight of the solvent of the rubber-containing liquid comprises water, the relatively higher solids contents may be preferred, e.g., about 30% to about 75% (e.g., 30%, 35%, 40%, 45%, 50%, 55%, 60%, 65%, 70%, 75%). In certain embodiments of the first embodiment wherein a majority by weight of the solvent of the rubber-containing liquid comprises water, the solids content of the rubber-containing liquid is about 10 to about 90% (e.g., 10%, 15%, 20%, 25%, 30%, 35%, 40%, 45%, 50%, 55%, 60%, 65%, 70%, 75%, 80%, 85%, 90%), 10 to 90%, about 20 to about 80%, 20 to 80%, about 30 to about 70%, 30 to 70%, about 35 to about 70%, 35 to 70%, about 35 to about 65%, or 35 to 65% by weight. In certain embodiments of the first embodiment wherein a majority by weight of the solvent of the rubber-containing liquid comprises at least one hydrocarbon solvent, the relatively lower amounts of solids may be preferred, e.g., about 10 to about 25%, 10 to 25%, about 10 to about 20%, 10 to 20%, about 10 to about 15%, or 10 to 15% by weight.

Rubber

As discussed above, according to the method of the first embodiment, the rubber-containing liquid utilized to treat the lower surface of the cured inner liner comprises at least one conjugated diene monomer-containing rubber. By conjugated diene monomer-containing rubber is meant a rubber polymer comprising at least one type of conjugated diene monomer. (The term polymer as used herein includes both homopolymers comprised of one type of monomer as well as copolymers comprised of two or more types of monomers.) It should be understood that the rubber or rubbers contained within the rubber-containing liquid will be the same rubber or rubbers contained within the rubber-containing film that is produced upon the lower surface of the inner liner. Similarly, as also discussed above the rubber-containing film of the second-fourth embodiments comprises at least one conjugated diene monomer-containing rubber. The rubber-containing liquid and/or rubber-containing film may comprise one or more than one conjugated diene monomer-containing rubber. While the concentration of conjugated diene monomer-containing rubber(s) within the rubber-containing liquid may vary (as discussed in more detail infra), the total amount of all conjugated diene monomer-containing rubber(s) should be understood as 100 parts or 100 phr so that the relative amount of other ingredients (e.g., solvent and optional ingredients such as filler(s), tackifier, antioxidant, plasticizer, and stabilizer/surfactant is provided in units of phr (i.e., parts per 100 parts rubber). In certain embodiments of the first-fourth embodiments, the rubber-containing liquid and/or the rubber-containing film is essentially free of polyurethane. By essentially free of polyurethane is meant that less than 5 phr, more preferably less than 2 phr or 0 phr is present in the rubber-containing liquid or in the rubber-containing film.

As those of skill in the art understand, a conjugated diene is a compound that has two double carbon-carbon bonds (i.e., two —C═C— bonds) that are separated by a single bond (i.e., —C—C—); thus, a conjugated diene will contain at least one —C═C—C═C— moiety. The particular structure of the conjugated diene monomer contained within the at least one conjugated diene monomer-containing rubber of the rubber-containing liquid and/or rubber-containing film of the first-fourth embodiments disclosed herein can vary. According to the first-fourth embodiments, one or more than one type of conjugated diene monomer can be utilized. By referring herein to one or more than one type of conjugated diene monomer is meant that the conjugated diene monomers may comprise all one formula or a mixture of formulas. As a non-limiting example, two types of conjugated diene monomers could encompass a combination of 1,3-butadiene and isoprene. In certain embodiments of the first-fourth embodiments disclosed herein, the conjugated diene monomer comprises at least one of 1,3-butadiene; isoprene; 1-3-pentadiene; 2,3-dimethyl-1,3-butadiene; 2-ethyl-1,3-butadiene; 2-methyl-1,3-pentadiene; 3-methyl-1,3-pentadiene; 4-methyl-1,3-pentadiene; 2,4-hexadiene; 1,3-hexadiene; 1,3-cyclopentadiene; 1,3-cyclohexadiene; 1,3-cycloheptadiene; or 1,3-cyclooctadiene. In certain embodiments of the first-fourth embodiments, the conjugated diene monomer comprises 1,3-butadiene. In certain embodiments of the first-fourth embodiments disclosed herein, the at least one conjugated diene monomer-containing rubber further comprises at least one type of vinyl aromatic monomer, i.e., in addition to the conjugated diene monomer. In certain embodiments of the first-fourth embodiments disclosed herein, the at least one type of vinyl aromatic monomer of the polymer chain comprises at least one of styrene, alpha-methyl styrene, p-methylstyrene, o-methylstyrene, p-butylstyrene, vinylnaphthalene, p-tertbutylstyrene, 4-vinylbiphenyl, 4-vinylbenzocyclobutene, 2-vinylnaphthalene, 9-vinylanthracene, 4-vinylanisole, or vinyl catechol. In certain embodiments of the first-fourth embodiments disclosed herein, the at least one type vinyl aromatic monomer of the conjugated diene monomer-containing rubber comprises styrene.

In certain embodiments of the first-fourth embodiments, the rubber of the rubber-containing liquid and/or rubber of the rubber-containing film comprises at least one of: butyl rubber (optionally halogenated), natural rubber, polyisoprene rubber, polybutadiene rubber (preferably at least 90% cis bond content, even more preferably at least 95% cis bond content), styrene-butadiene rubber, styrene-butadiene-isoprene rubber, isoprene-butadiene rubber, polychloroprene rubber, EPDM (ethylene-propylene-diene terpolymer rubber), or nitrile rubber; in certain such embodiments, the rubber-containing liquid and/or the rubber-containing film is essentially free of polyurethane. By essentially free of polyurethane is meant that less than 5 phr, more preferably less than 2 phr or 0 phr is present in the rubber-containing liquid or in the rubber-containing film. In certain embodiments of the first-fourth embodiments, at least 80% by weight of the rubber(s) of the rubber-containing liquid and/or rubber of the rubber-containing film comprises at least one of: butyl rubber (optionally halogenated), natural rubber, polyisoprene rubber, polybutadiene rubber (preferably at least 90% cis bond content, even more preferably at least 95% cis bond content), styrene-butadiene rubber, styrene-butadiene-isoprene rubber, isoprene-butadiene rubber, polychloroprene rubber, EPDM, or nitrile rubber; in certain such embodiments, the rubber-containing liquid and/or the rubber-containing film is essentially free of polyurethane. In certain embodiments of the first-fourth embodiments, all 100 parts or 100 phr (in other words no other rubbers are present other than the optional low molecular weight polymer or oligomer as tackifier) of the rubber(s) of the rubber-containing liquid and/or rubber of the rubber-containing film comprises one or more of the following rubbers: butyl rubber (optionally halogenated), natural rubber, polyisoprene rubber, polybutadiene rubber (preferably at least 90% cis bond content, even more preferably at least 95% cis bond content), styrene-butadiene rubber, styrene-butadiene-isoprene rubber, isoprene-butadiene rubber, polychloroprene rubber, EPDM, or nitrile rubber; in certain such embodiments, the rubber-containing liquid and/or the rubber-containing film is essentially free of polyurethane. In certain embodiments of the first-fourth embodiments, at least 80% by weight of the rubber(s) of the rubber-containing liquid and/or rubber-containing film comprises a combination of butyl rubber, halogenated butyl rubber, and EPDM rubber.

In certain embodiments of the first-fourth embodiments, the rubber of the rubber-containing liquid and/or rubber-containing film comprises at least one butyl rubber; in certain such embodiments at least 80% by weight of the rubber(s) of the rubber-containing liquid and/or rubber-containing film comprises at last one butyl rubber. In certain embodiments of the first-fourth embodiments, the rubber of the rubber-containing liquid and/or rubber-containing film comprises at least one halogenated butyl rubber; in certain such embodiments at least 80% by weight of the rubber(s) of the rubber-containing liquid and/or rubber-containing film comprises at least one halogenated butyl rubber. In certain embodiments of the first-fourth embodiments, the rubber of the rubber-containing liquid and/or rubber-containing film comprises at least one butyl rubber in combination with at least one halogenated butyl rubber; in certain such embodiments at least 80% by weight of the rubber(s) of the rubber-containing liquid and/or rubber-containing film comprises at least one butyl rubber in combination with at least one halogenated butyl rubber. In certain embodiments of the first-fourth embodiments, the rubber of the rubber-containing liquid and/or rubber-containing film comprises at least one natural rubber; in certain such embodiments at least 80% by weight of the rubber(s) of the rubber-containing liquid and/or rubber-containing film comprises at least one natural rubber. In certain embodiments of the first-fourth embodiments, the rubber of the rubber-containing liquid and/or rubber-containing film comprises at least one polyisoprene rubber; in certain such embodiments at least 80% by weight of the rubber(s) of the rubber-containing liquid and/or rubber-containing film comprises at least one polyisoprene rubber. In certain embodiments of the first-fourth embodiments, the rubber of the rubber-containing liquid and/or rubber-containing film comprises at least one polybutadiene rubber; in certain such embodiments at least 80% by weight of the rubber(s) of the rubber-containing liquid and/or rubber-containing film comprises at least one polybutadiene rubber. In certain embodiments of the first-fourth embodiments, the rubber of the rubber-containing liquid and/or rubber-containing film comprises at least one styrene-butadiene rubber; in certain such embodiments at least 80% by weight of the rubber(s) of the rubber-containing liquid and/or rubber-containing film comprises at least one styrene-butadiene rubber. In certain embodiments of the first-fourth embodiments, the rubber of the rubber-containing liquid and/or rubber-containing film comprises at least one styrene-butadiene-isoprene rubber; in certain such embodiments at least 80% by weight of the rubber(s) of the rubber-containing liquid and/or rubber-containing film comprises at least one styrene-butadiene-isoprene rubber. In certain embodiments of the first-fourth embodiments, the rubber of the rubber-containing liquid and/or rubber-containing film comprises at least one isoprene-butadiene rubber; in certain such embodiments at least 80% by weight of the rubber(s) of the rubber-containing liquid and/or rubber-containing film comprises at least one isoprene-butadiene rubber. In certain embodiments of the first-fourth embodiments, the rubber of the rubber-containing liquid and/or rubber-containing film comprises at least one polychloroprene rubber; in certain such embodiments at least 80% by weight of the rubber(s) of the rubber-containing liquid and/or rubber-containing film comprises at least one polychloroprene rubber. In certain embodiments of the first-fourth embodiments, the rubber of the rubber-containing liquid and/or rubber-containing film comprises at least one EPDM rubber; in certain such embodiments at least 80% by weight of the rubber(s) of the rubber-containing liquid and/or rubber-containing film comprises at least one EPDM rubber. In certain embodiments of the first-fourth embodiments, the rubber of the rubber-containing liquid and/or rubber-containing film comprises at least one nitrile rubber; in certain such embodiments at least 80% by weight of the rubber(s) of the rubber-containing liquid and/or rubber-containing film comprises at least one nitrile rubber.

Solvent

As discussed above, according to the method of the first embodiment, the rubber-containing liquid utilized to treat the lower surface of the cured inner liner comprises at least one solvent. By solvent is meant a compound capable of solubilizing the at least one conjugated diene monomer-containing rubber. As discussed in more detail below, after removal or evaporation of the solvent(s) of the rubber-containing liquid, a rubber-containing film is left behind on the lower surface of the cured inner liner. The rubber-containing liquid may comprise one or more than one solvent. As those of skill in the art will appreciate, the solvent or solvents of the rubber-containing liquid may be selected so as to create a rubber-containing liquid which has a volatile organic carbon (VOC) content of 250 grams/liter or less (as measured by EPA Method 24). Alternatively, in other embodiments of the first embodiment, the VOC content of the rubber-containing liquid may be somewhat higher, e.g., about 255 to 700 grams/liter (e.g., 255, 275, 300, 325, 350, 375, 400, 425, 450, 475, 500, 525, 550, 575, 600, 625, 650, 675, 700 grams/liter), 300-700 grams/liter, 400-700 grams/liter, or 500-700 grams/liter.

According to the first embodiment, the amount of solvent in the rubber-containing liquid may vary. In certain embodiments of the first embodiment, the rubber-containing liquid comprises about 50 to about 2000 phr (e.g., 50 phr, 100 phr, 200 phr, 250 phr, 300 phr, 400 phr, 500 phr, 600 phr, 700 phr, 800 phr, 900 phr, 1000 phr, 1100 phr, 1200 phr, 1300 phr, 1400 phr, 1500 phr, 1600 phr, 1700 phr, 1800 phr, 1900 phr, 2000 phr) of at least one solvent. In certain embodiments of the first embodiment, the rubber-containing liquid comprises 100-2000 phr, 100-1600 phr, 100-1200 phr, 100-1000 phr, 200-2000 phr, 200-1600 phr, 200-1200 phr, 200-1000 phr, 400-2000 phr, 400-1600 phr, 400-1200 phr, 400-1000 phr, 500-2000 phr, 500-1600 phr, 500-1200 phr, 500-1000 phr, 700-2000 phr, 700-1600 phr, 700-1200 phr, or 700-1000 phr of at least one solvent.

In certain embodiments of the first embodiment, the solvent of the rubber-containing liquid comprises a majority by weight (e.g., at least 51%, at least 55%, at least 60%, at least 65%, at least 70%, at least 75%, at least 80%, at least 85%, at least 90%, at least 95%, at least 98%, at least 99% or even 100% by weight of the solvent) of at least one hydrocarbon solvent. One or more than one hydrocarbon solvent may be utilized in the rubber-containing liquid. In certain embodiments, the at least one hydrocarbon solvent is selected from: alkanes having 4-12 carbons (e.g., butane, propane, hexane, heptane, naphtha); cycloalkanes and alkyl-cycloalkanes having 5-10 carbons (e.g., cyclopentane, cyclohexane); aromatic hydrocarbons and alkyl-substituted aromatic hydrocarbons having 6-12 carbons (e.g., benzene, toluene, xylene); non-halogenated alkenes having 2-20 carbons (e.g., 1-dodecene, 1-tetradecene); and combinations thereof. In certain embodiments of the first embodiment, the solvent of the rubber-containing liquid comprises a majority by weight (e.g., at least 51%, at least 55%, at least 60%, at least 65%, at least 70%, at least 75%, at least 80%, at least 85%, at least 90%, at least 95%, at least 98%, at least 99% or even 100% by weight of the solvent) of at least one aromatic hydrocarbon having 6-12 carbons, at least one alkyl-substituted aromatic hydrocarbon having 6-12 carbons, or a combination thereof. In certain embodiments of the first embodiment, the solvent of the rubber-containing liquid may further comprise at least one additional solvent selected from: alcohols having 1-8 carbons (e.g., methanol, ethanol, propanol, isopropanol) and ketones having 3-8 carbons (e.g., acetone, methyl-ethyl ketone); in such embodiments, the total amount of alcohol and/or ketone is preferably no more than 20% by weight, no more than 10% by weight, or no more than 5% by weight of the total amount of solvent so as to avoid precipitation of the at least one conjugated diene monomer-containing rubber from the rubber-containing liquid. As a non-limiting example, assuming 800 phr of solvent in the rubber-containing liquid, 5% by weight acetone would be 40 phr acetone and 95% by weight hexane would be 760 phr.

In certain embodiments of the first embodiment, the solvent of the rubber-containing liquid comprises a majority by weight (e.g., at least 51%, at least 55%, at least 60%, at least 65%, at least 70%, at least 75%, at least 80%, at least 85%, at least 90%, at least 95%, at least 98%, at least 99% or even 100% by weight of the solvent) of at least one halogenated aromatic hydrocarbon solvent, at least one halogenated C1-C6 alkane, at least one halogenated C2-C6 alkene, or a combination thereof. Suitable halogenated aromatic hydrocarbon solvents, halogenated C1-C6 alkanes, and halogenated C2-C6 alkenes include those recognized by the environmental agencies of the United States or Canada as exempt as of the filing date of this application other than alcohols, ketones, esters, siloxanes, and gases. In certain embodiments of the first embodiment, the solvent of the rubber-containing liquid comprises a majority by weight of at least one of the following: methylene chloride (dichloromethane); 1,1,1-trichloroethane (methyl chloroform); 1,1,2-trichloro-1,2,2-trifluoroethane (CFC-113); trichlorofluoromethane (CFC-11); dichlorodifluoromethane (CFC-12); chlorodifluoromethane (HCFC-22); trifluoromethane (HFC-23); 1,2-dichloro 1,1,2,2-tetrafluoroethane (CFC-114); chloropentafluoroethane (CFC-115); 1,1,1-trifluoro 2,2-dichloroethane (HCFC-123); 1,1,1,2-tetrafluoroethane (HFC-134a); 1,1-dichloro 1-fluoroethane (HCFC-141b); 1-chloro 1,1-difluoroethane (HCFC-142b); 2-chloro-1,1,1,2-tetrafluoroethane (HCFC-124); pentafluoroethane (HFC-125); 1,1,2,2-tetrafluoroethane (HFC-134); 1,1,1-trifluoroethane (HFC-143a); 1,1-difluoroethane (HFC-152a); parachlorobenzotrifluoride (PCBTF); perchloroethylene (tetrachloroethylene); 3,3-dichloro-1,1,1,2,2-pentafluoropropane (HCFC-225ca); 1,3-dichloro-1,1,2,2,3-pentafluoropropane (HCFC-225cb); 1,1,1,2,3,4,4,5,5,5-decafluoropentane (HFC 43-10mee); difluoromethane (HFC-32); ethylfluoride (HFC-161); 1,1,1,3,3,3-hexafluoropropane (HFC-236fa); 1,1,2,2,3-pentafluoropropane (HFC-245ca); 1,1,2,3,3-pentafluoropropane (HFC-245ea); 1,1,1,2,3-pentafluoropropane (HFC-245eb); 1,1,1,3,3-pentafluoropropane (HFC-245fa); 1,1,1,2,3,3-hexafluoropropane (HFC-236ea); 1,1,1,3,3-pentafluorobutane (HFC-365mfc); chlorofluoromethane (HCFC-31); 1 chloro-1-fluoroethane (HCFC-151a); 1,2-dichloro-1,1,2-trifluoroethane (HCFC-123a); 1,1,1,2,2,3,3,4,4-nonafluoro-4-methoxy-butane (C₄F₉OCH₃ or HFE-7100); 2-(difluoromethoxymethyl)-1,1,1,2,3,3,3-heptafluoropropane ((CF₃)₂CFCF₂OCH₃); 1-ethoxy -1,1,2,2,3,3,4,4,4-nonafluorobutane (C₄F₉OC₂H₅ or HFE-7200); 2-(ethoxydifluoromethyl)-1,1,1,2,3,3,3-heptafluoropropane ((CF₃)₂CFCF₂OC₂H₅); 1,1,1,2,2,3,3-heptafluoro-3-methoxy-propane (n-C₃F₇OCH₃, HFE-7000); 3-ethoxy-1,1,1,2,3,4,4,5,5,6,6,6-dodecafluoro-2-(trifluoromethyl) hexane (HFE-7500); 1,1,1,2,3,3,3-heptafluoropropane (HFC 227ea); 1,1,1,2,2,3,4,5,5,5-decafluoro-3-methoxy-4-trifluoromethyl-pentane (HFE-7300); trans-1,3,3,3-tetrafluoropropene; HCF₂OCF₂H (HFE-134); HCF₂OCF₂OCF₂H (HFE-236cal2); HCF₂OCF₂CF₂OCF₂H (HFE-338pcc13); HCF₂OCF₂OCF₂CF₂OCF₂H (H-Galden 1040x or H-Galden ZT 130 (or 150 or 180)); trans 1-chloro-3,3,3-trifluoroprop-1-ene; 2,3,3,3-tetrafluoropropene; perfluorocarbon compounds which fall into the following classes: (i) cyclic, branched, or linear, completely fluorinated alkanes; or (ii) cyclic, branched, or linear, completely fluorinated ethers with no unsaturations; and combinations thereof. One or more than one halogenated aromatic hydrocarbon solvent, one or more than one halogenated C1-C6 alkane, one or more than one halogenated C1-C6 alkene, or a combination thereof may be utilized. In certain embodiments of the first embodiment, the rubber-containing liquid further comprises a minority by weight of at least one hydrocarbon solvent (as discussed above, i.e., alkanes having 4-12 carbons, cycloalkanes and alkyl-cycloalkanes having 5-10 carbons, aromatic hydrocarbons and alkyl-substituted aromatic hydrocarbons, non-halogenated alkenes having 2-20 carbons). As used herein, the term minority by weight refers to less than 50% and include 49% or less, 45% or less, 40% or less, 30% or less, 20% or less, 15% or less, 10% or less, and 5% or less. It should be understood that it is possible to formulate a rubber-containing liquid which has a VOC content of 250 grams/liter or less by utilizing a majority of weight of at least one halogenated aromatic hydrocarbon solvent, optionally in combination with a minority by weight of at least one hydrocarbon solvent. In certain embodiments of the first embodiment, the solvent of the rubber-containing liquid may further comprise at least one additional solvent selected from: alcohols having 1-8 carbons (e.g., methanol, ethanol, propanol, isopropanol) and ketones having 3-8 carbons (e.g., acetone, methyl-ethyl ketone); in such embodiments, the total amount of alcohol and/or ketone is preferably no more than 20% by weight, no more than 10% by weight, or no more than 5% by weight of the total amount of solvent so as to avoid precipitation of the at least one conjugated diene monomer-containing rubber from the rubber-containing liquid. In certain embodiments of the first embodiment, the solvent of the rubber-containing liquid comprises a majority by weight (e.g., at least 51%, at least 55%, at least 60%, at least 65%, at least 70%, at least 75%, at least 80%, at least 85%, at least 90%, at least 95%, at least 98%, at least 99% or even 100% by weight of the solvent) of parachlorobenzotrifluoride (also known as 1-chloro-4-(trifluoromethyl)benzene).

In certain embodiments of the first embodiment, the solvent of the rubber-containing liquid comprises a majority by weight (e.g., at least 51%, at least 55%, at least 60%, at least 65%, at least 70%, at least 75%, at least 80%, at least 85%, at least 90%, at least 95%, at least 98%, at least 99% or even 100% by weight of the solvent) of water. In certain embodiments of the first embodiment, when at least a majority by weight of the solvent of the rubber-containing liquid comprises water, at least a portion of the water is added to the rubber-containing liquid via use of a rubber latex (e.g., at least one conjugated diene monomer-containing rubber suspended in water). When a water-based rubber latex is utilized, the concentration of rubber in the latex may vary; in certain such embodiments, the concentration of rubber is about 5 to about 75% (e.g., 5%, 10%, 15%, 20%, 25%, 30%, 35%, 40%, 45%, 50%, 55%, 60%, 65%, 70%, 75%) by weight rubber (based upon the total weight of the rubber latex), including 5-75% by weight rubber, 10-65% by weight rubber, 20-65% by weight rubber, 30-65% by weight rubber, 40-65% by weight rubber, 10-55% by weight rubber, 20-55% by weight rubber, 30-55% by weight rubber, or 40-55% by weight rubber. Alternatively, the amount of water used as solvent in the rubber-containing liquid can be described in terms of parts per 100 parts of rubber (i.e., total amount of at least one conjugated diene monomer-containing rubber); in certain such embodiments, the amount of water in the rubber-containing liquid is about 35 to about 500 phr (e.g., 35 phr, 50 phr, 75 phr, 100 phr, 150 phr, 200 phr, 250 phr, 300 phr, 350 phr, 400 phr, 500 phr), including 35-500 phr, 35-400 phr, 35-300 phr, 35-200 phr, 50-500 phr, 50-400 phr, 50-300 phr, 50-200 phr, 100-500 phr, 100-400 phr, 100-300 phr, 100-200 phr water. As non-limiting examples, assuming 100 parts of rubber and 50 parts of water would yield a solids content of about 65% or assuming 100 parts of rubber, 40 parts of tackifier and 200 parts of water would yield a solids content of about 40%. In certain embodiments of the first embodiment, wherein at least a majority by weight of the solvent in the rubber-containing liquid comprises water, the pH of the rubber-containing liquid is about 7 to about 14, 7-14, about 7 to about 13, 7-13, about 7 to about 12, 7-12, about 7 to about 11, 7-11, about 8 to about 13, 8-13, about 9 to about 12, or about 9-12.

Tackifier

In certain embodiments of the first-fourth embodiments, the rubber-containing liquid and/or rubber-containing film further comprise (contain) at least one tackifier. One or more than one tackifier may be utilized. As used herein, the term tackifier encompasses hydrocarbons resins (e.g., natural resins, synthetic resins, and combinations thereof) as well as low molecular weight polymer or oligomers (e.g., having a weight average molecular weight or Mw of 100,000 grams/mole or less, preferably 50,000 grams/mole or less). Mw and Mn values referred to herein can be determined by gel permeation chromatography (GPC) calibrated with polystyrene standards. The use of at least one tackifier in the rubber-containing liquid (which will result in the presence of tackifier in the rubber-containing film) may be particularly beneficial in those embodiments wherein a majority by weight of the solvent comprises water.

According to the first-fourth embodiments, when at least one tackifier is utilized in the rubber-containing liquid or is present in the rubber-containing film, the amount utilized may vary. In certain embodiments of the first-fourth embodiments, the rubber-containing liquid and/or rubber-containing film comprises at least one tackifier in an amount of about 5 to about 50 phr (e.g., 5 phr, 10 phr, 15 phr, 20 phr, 25 phr, 30 phr, 35 phr, 40 phr, 45 phr, 50 phr). In certain embodiments of the first-fourth embodiments, the rubber-containing liquid and/or rubber-containing film comprises about 5 to about 40 phr, 5 to 40 phr, about 5 to about 30 phr, 5 to 30 phr, about 10 to about 40 phr, 10 to 40 phr, about 10 to about 30 phr, or 10 to 30 phr of at least one tackifier. When more than one tackifier is utilized, the foregoing amounts should be understood to refer to the total amount of all tackifiers.

In certain embodiments of the first-fourth embodiments, the rubber-containing liquid and/or rubber-containing film comprises at least one hydrocarbon resin comprising a natural resin. In certain embodiments of the first-fourth embodiments, the only tackifier is one or more hydrocarbon resins in the form of natural resin. In certain embodiments of the first-fourth embodiments, the rubber-containing liquid and/or rubber-containing film comprises at least one hydrocarbon resin comprising a synthetic resin. By synthetic resin is meant a polymerized form of a resin wherein the polymerization does not occur in nature but occurs by manufacturing, although the monomer(s) that are polymerized may be naturally-occurring. In certain embodiments of the first-fourth embodiments, the only hydrocarbon resin or resins are synthetic resins. According to the first-fourth embodiments, when at least one hydrocarbon resin is utilized (as tackifier) in the rubber-containing liquid and/or rubber-containing film, the amount utilized may vary. In certain embodiments of the first-fourth embodiments, the rubber-containing liquid and/or rubber-containing film comprises about 5 to about 50 phr (e.g., 5 phr, 10 phr, 15 phr, 20 phr, 25 phr, 30 phr, 35 phr, 40 phr, 45 phr, 50 phr) of the at least one hydrocarbon resin. In certain embodiments of the first-fourth embodiments, the rubber-containing liquid and/or rubber-containing film comprises about 5 to about 40 phr, 5 to 40 phr, about 5 to about 30 phr, 5 to 30 phr, about 10 to about 40 phr, 10 to 40 phr, about 10 to about 30 phr, or 10 to 30 phr of at least one hydrocarbon resin as tackifier.

In certain embodiments of the first-fourth embodiments, the rubber-containing liquid and/or rubber-containing film comprises at least one tackifier in the form of a hydrocarbon resin wherein the hydrocarbon resin comprises at least one of a/an: aliphatic resin, hydrogenated aliphatic resin, cycloaliphatic resin, hydrogenated cycloaliphatic resin, aromatic resin, hydrogenated aromatic resin, terpene resin, aliphatic/aromatic resin, or rosin resin. According to the first-fourth embodiments, the at least one hydrocarbon resin can be a combination of the foregoing types of resins (e.g., an aliphatic/aromatic resin contains both an aliphatic and an aromatic component) and, thus, a particular hydrocarbon resin may be considered to fall within more than one category.

In certain embodiments of the first-fourth embodiments, the rubber-containing liquid and/or rubber-containing film comprises (as tackifier) at least one hydrocarbon resin comprising an aliphatic resin, optionally in combination with one or more of the foregoing resins (e.g., cycloaliphatic, hydrogenated cycloaliphatic, aromatic, hydrogenated aromatic, terpene, rosin) and/or optionally partially or fully hydrogenated. Non-limiting examples of aliphatic resins suitable for use as a tackifier in the rubber-containing liquid and/or rubber-containing film of certain embodiments of the first-fourth embodiments include C5 fraction homopolymer or copolymer resins. Non-limiting examples of aliphatic copolymer resins include C5 fraction/C9 fraction copolymer resins, C5 fraction/vinylaromatic copolymer resins (e.g., C5 fraction/styrene copolymer resin). In certain embodiments of the first-fourth embodiments when the tackifier comprises an aliphatic resin, it is partially or fully hydrogenated.

In certain embodiments of the first-fourth embodiments, the rubber-containing liquid and/or rubber-containing film comprises (as tackier) at least one hydrocarbon resin comprising a cycloaliphatic resin, optionally in combination with one or more of the foregoing resins (e.g., aliphatic, hydrogenated aliphatic, aromatic, hydrogenated aromatic, terpene, rosin) and/or optionally partially or fully hydrogenated. Non-limiting examples of cycloaliphatic resins suitable for use as a tackifier in the rubber-containing liquid and/or rubber-containing film of certain embodiments of the first-fourth embodiments include cyclopentadiene (“CPD”) homopolymer or copolymer resins, and dicyclopentadiene (“DCPD”) homopolymer or copolymer resins. Non-limiting examples of cycloaliphatic copolymer resins include CPD/vinyl aromatic copolymer resins, DCPD/vinyl aromatic copolymer resins, CPD/terpene copolymer resins, DCPD/terpene copolymer resins, CPD/aliphatic copolymer resins (e.g., CPD/C5 fraction copolymer resins), DCPD/aliphatic copolymer resins (e.g., DCPD/C5 fraction copolymer resins), CPD/aromatic copolymer resins (e.g., CPD/C9 fraction copolymer resins), DCPD/aromatic copolymer resins (e.g., DCPD/C9 fraction copolymer resins), CPD/vinyl aromatic copolymer resins (e.g., CPD/styrene copolymer resins), DCPD/vinyl aromatic copolymer resins (e.g., DCPD/styrene copolymer resins), CPD/terpene copolymer resins (e.g., limonene/CPD copolymer resin), and DCPD/terpene copolymer resins (e.g., limonene/DCPD copolymer resins). In certain embodiments of the first-fourth embodiments when the tackifier comprises a cycloaliphatic resin, it is partially or fully hydrogenated.

In certain embodiments of the first-fourth embodiments, the rubber-containing liquid and/or rubber-containing film comprises (as tackifier) at least one hydrocarbon resin comprising an aromatic resin, optionally in combination with one or more of the foregoing resins (e.g., aliphatic, hydrogenated aliphatic, cycloaliphatic, hydrogenated cycloaliphatic, hydrogenated aromatic, terpene, rosin) and/or optionally partially or fully hydrogenated. Non-limiting examples of aromatic resins suitable for use as a tackifier in the rubber-containing liquid and/or rubber-containing film of certain embodiments of the first-fourth embodiments include coumarone-indene resins and alkyl-phenol resins as well as vinyl aromatic homopolymer or copolymer resins such as those including one or more of the following monomers: alpha-methylstyrene, styrene, ortho-methylstyrene, meta-methylstyrene, para-methylstyrene, vinyltoluene, para(tert-butyl)styrene, methoxystyrene, chlorostyrene, hydroxystyrene, vinylmesitylene, divinylbenzene, vinylnaphthalene or any vinyl aromatic monomer resulting from C9 fraction or C8-C10 fraction. Non-limiting examples of vinylaromatic copolymer resins include vinylaromatic/terpene copolymer resins (e.g., limonene/styrene copolymer resins), vinylaromatic/C5 fraction resins (e.g., C5 fraction/styrene copolymer resin), vinylaromatic/aliphatic copolymer resins (e.g., CPD/styrene copolymer resin, and DCPD/styrene copolymer resin). Non-limiting examples of alkyl-phenol resins include alkylphenol-acetylene resins such as p-tert-butylphenol-acetylene resins, alkylphenol-formaldehyde resins (such as those having a low degree of polymerization). In certain embodiments of the first-fourth embodiments when the tackifier comprises an aromatic resin, it is partially or fully hydrogenated.

In certain embodiments of the first-fourth embodiments, the rubber-containing liquid and/or rubber-containing film comprises (as tackifier) at least one hydrocarbon resin comprising a terpene resin, optionally in combination with one or more of the foregoing resins (e.g., aliphatic, cycloaliphatic, aromatic, hydrogenated aromatic) and/or optionally partially or fully hydrogenated. Non-limiting examples of terpene resins suitable for use as a tackifier in the rubber-containing liquid and/or rubber-containing film of certain embodiments of the first-fourth embodiments include alpha-pinene resins, beta-pinene resins, limonene resins (e.g., L-limonene, D-limonene, dipentene which is a racemic mixture of L- and D-isomers), beta-phellandrene, delta-3-carene, and delta-2-carene; in certain embodiments of the first-fourth embodiments, the terpene resin is a terpene copolymer resin comprising at least one of the foregoing terpenes in combination with one or more of the foregoing resins (e.g., aliphatic, hydrogenated aliphatic, cycloaliphatic, hydrogenated cycloaliphatic, aromatic, hydrogenated aromatic, rosin). An exemplary homopolymer terpene resin is polylimonene. Non-limiting examples of terpene copolymer resins include aliphatic/terpene resins (e.g., DCPD/terpene copolymer resins, and CPD/terpene copolymer resins), terpene/phenol copolymer resins, terpene/vinylaromatic copolymer resins (e.g., limonene/styrene copolymer resins). In certain embodiments of the first-fourth embodiments, when a terpene resin is utilized, its source may be guayule resin, and, thus, the terpene resin may be considered to be guayule resin or guayule terpene resin.

In certain embodiments of the first-fourth embodiments, the rubber-containing liquid and/or rubber-containing film comprises (as tackifier) at least one hydrocarbon resin comprising a rosin resin, optionally in combination with one or more of the foregoing resins (e.g., aliphatic, hydrogenated aliphatic, cycloaliphatic, hydrogenated cycloaliphatic, aromatic, hydrogenated aromatic, terpene) and/or optionally partially or fully hydrogenated. Non-limiting examples of rosin resins suitable for use as a tackifier in the rubber-containing liquid and/or rubber-containing film of certain embodiments of the first-fourth embodiments include gum rosin, wood rosin, and tall oil rosin. Non-limiting examples of modified rosin resins include glycerin ester rosins, and pentaerythritol ester rosins (optionally partially hydrogenated and/or polymerized).

In certain embodiments of the first-fourth embodiments, the rubber-containing liquid and/or rubber-containing film comprises at least one tackifier comprising a low molecular weight polymer or oligomer. In certain embodiments of the first-fourth embodiments, the only hydrocarbon resin or resins are low molecular weight polymers or oligomers. In certain embodiments of the first-fourth embodiments, the rubber-containing liquid and/or rubber-containing film comprises 40-120 phr (e.g., 40 phr, 45 phr, 50 phr, 55 phr, 60 phr, 65 phr, 70 phr, 75 phr, 80 phr, 85 phr, 90 phr, 95 phr, 100 phr, 105 phr, 110 phr, 115 phr, 120 phr) of at least one low molecular weight polymer or oligomer. In certain embodiments of the first-fourth embodiments, the rubber-containing liquid and/or rubber-containing film comprises 40-110 phr, 50-110 phr, 60-110 phr, 70-110 phr, 40-100 phr, 50-100 phr, 60-100 phr, 70-100 phr of at least one low molecular weight polymer or oligomer. In certain embodiments of the first-fourth embodiments, the rubber-containing liquid and/or rubber-containing film comprises at least one low molecular weight polymer or oligomer having a Mw of about 700 to about 50,000 grams/mole (e.g., 700 grams/mole; 750 grams/mole; 1000 grams/mole; 2500 grams/mole; 5000 grams/mole; 7500 grams/mole; 10000 grams/mole; 15,000 grams/mole; 20,000 grams/mole; 25,000 grams/mole; 30,000 grams/mole; 35,000 grams/mole; 40,000 grams/mole; 45,000 grams/mole; 50,000 grams/mole), including 1000-50,000 grams/mole; 1000-40,000 grams/mole; 1000-25,000 grams/mole; 1000-15000 grams/mole; 1000-10,00 grams/mole; 1000-7500 grams/mole; 1000-5000 grams/mole. In certain embodiments of the first-fourth embodiments, the rubber-containing liquid and/or rubber-containing film comprises at least one low molecular weight polymer or oligomer having a Mn of about 500 to about 40,000 grams/mole (e.g., 500 grams/mole; 600 grams/mole; 750 grams/mole; 1000 grams/mole; 3000 grams/mole; 5000 grams/mole; 7500 grams/mole; 10,000 grams/mole; 15,000 grams/mole; 20,000 grams/mole; 25,000 grams/mole; 30,000 grams/mole; 35,000 grams/mole; 40,000 grams/mole), including 750-40,000 grams/mole; 750-25,000 grams/mole; 750-15,000 grams/mole; 750-10,000 grams/mole; 750-5000 grams/mole; and 750-3000 grams/mole.

In certain embodiments of the first-fourth embodiments, the rubber-containing liquid and/or rubber-containing film comprises at least one tackifier comprising polybutene. Exemplary polybutenes for use as a tackifier include, but are not limited to, Indopol® polybutenes from Ineos Oligomers (League City, Tex.) as grades H-100, H-300, H-1500, or H-1900.

In certain embodiments of the first-fourth embodiments, the rubber-containing liquid and/or rubber-containing film comprises at least one low molecular weight polymer or oligomer comprised of aliphatic monomer(s), aromatic monomer(s), or a combination thereof. One of more of each type of monomer may be used, as well as combinations thereof. The aliphatic monomer may be a linear, branched or cycloaliphatic monomer. Exemplary aliphatic monomers include: C4 paraffins, C5 paraffins, C6 parafins, olefins, conjugated diener, and combinations thereof. More specific examples of aliphatic monomers include: 1,3-butadiene; butene; isobutylene; 1,3-pentadiene; 1,4-pentadiene; cyclopentane; 1-pentene; 2-pentene; 2-methyl-1-pentene; 2-methyl-2-butene; 2-methyl-2-pentene; isoprene; cyclohexane; 1,3-hexadiene; 1,4-hexadiene; cyclopentadiene; dicyclopentadiene; and combinations thereof. The aromatic monomer may be optionally substituted with one or more hydrocarbon groups. Exemplary aromatic monomers include: styrene, indene, C8 aromatics, C9 aromatics; C10 aromatics; and combinations thereof.

Terpenes and Terpenoids

In certain embodiments of the first embodiment, the rubber-containing liquid comprises at least one terpene, terpenoid, terpene derivative, or a combination thereof. One or more than one terpene, one or more than one terpenoid, one or more than one terpene derivative, or a combination thereof may be utilized. As used herein, the term terpene refers to volatile, unsaturated hydrocarbon compounds found in the essential oils of various plants (e.g., citrus and evergreens), many of which contain or are based upon a C₁₀C₁₆ mono-cyclic moiety. Non-limiting examples of terpenes include: d-limonene, limonene, alpha-pinene, beta-pinene, dipinene, dipentene (also known as racemic limonene), d-verbenone, camphene (also known as 2,2-Dimethyl-3-methylenebicyclo[2.2.1]heptane), alpha-thugene, beta-myrcene, delta-3-carene, terpinolene (including terpinen-4-ol), borneol (also known as camphol), beta-ocimene, santolina triene, and combinations thereof. As used herein, the term terpene derivative refers to compounds such as can be derived by oxygenating terpenes or alcohol versions thereof; citronellene is a non-limiting example of a terpene derivative. As used herein, the term terpenoid refers to compounds that are generally obtained from plants (although the same compounds can also be synthesized) and based upon isoprene units; a terpenoid can be considered a modified form of a terpene wherein methyl groups have been removed or moved and oxygen atoms have been added; carvone, citral, 1-8-cineole (also known as eucalyptol), citronellol, geraniol, and camphor (also known as (±)-Camphor, 1,7,7-Trimethylbicyclo[2.2.1]heptan-2-one) are non-limiting examples of terpenoids. In certain embodiments of the first embodiment, the at least one terpene, terpenoid, terpene derivative, or a combination thereof can be understood as functioning within the rubber-containing liquid as a penetrant. Generally, a penetrant functions to open up the interstitial spaces of the polymeric matrix of a rubber surface to which it is applied, which can allow the other ingredients of the rubber-containing liquid to better penetrate and intermingle with the lower surface of the inner liner. In certain embodiments of the first embodiment, guayule resin can be used as a source of both tackifier and terpenes.

Depending upon the particular terpene(s), terpenoid(s), and/or terpene derivative(s) utilized in the rubber-containing liquid, the terpene(s), terpenoid(s) and/or terpene derivative(s) may be present in the rubber-containing film (i.e., after the rubber-containing liquid dries), may penetrate into the inner liner, or may be present in both the rubber-containing film and the inner liner. Accordingly, the discussion of types and amounts of terpene(s), terpenoid(s), and terpene derivative(s) contained herein should be understood to apply not only to the rubber-containing liquid but also the resulting rubber-containing film in certain embodiments of the first-fourth embodiments.

According to the first embodiment, when at least one terpene, terpenoid, terpene derivative, or a combination thereof is utilized in the rubber-containing liquid, the amount utilized may vary. In certain embodiments of the first embodiment, the total amount of at least one terpene, terpenoid, terpene derivative, or a combination thereof in the rubber-containing liquid is about 5 to about 50 phr (e.g., 5 phr, 10 phr, 15 phr, 20 phr, 25 phr, 30 phr, 35 phr, 40 phr, 45 phr, 50 phr). In certain embodiments of the first embodiment, the total amount of at least one terpene, terpenoid, terpene derivative, or a combination thereof in the rubber-containing liquid is 5 to 50 phr, about 5 to about 40 phr, 5 to 40 phr, about 5 to about 25 phr, 5 to 25 phr, about 5 to about 15 phr, or 5 to 15 phr.

Filler

In certain embodiments of the first-fourth embodiments, the rubber-containing liquid and/or the rubber-containing film contains (further comprises) at least one filler. (Generally, any filler that is present in the rubber-containing liquid will remain present in the rubber-containing film that forms when that liquid dries.) In certain embodiments of the first-fourth embodiments, the at least one filler comprises a reinforcing filler. One or more than one filler or reinforcing filler may be utilized in the rubber-containing liquid or be present in the rubber-containing film. The total amount of filler(s) used in the rubber-containing liquid or present in the rubber-containing film may vary. In certain embodiments of the first-fourth embodiments, the rubber-containing liquid and/or the rubber-containing film contains (further comprises) at least one filler in an amount of about 5 to about 100 phr (e.g., 5 phr, 10 phr, 15 phr, 20 phr, 25 phr, 30 phr, 35 phr, 40 phr, 45 phr, 50 phr, 55 phr, 60 phr, 65 phr, 70 phr, 75 phr, 80 phr, 85 phr, 90 phr, 100 phr); in certain such embodiments the at least one filler comprises at least one reinforcing filler. In certain embodiments of the first-fourth embodiments, the rubber-containing liquid and/or rubber-containing film contain (further comprise) at least one filler in an amount of about 5 to about 80 phr, 5 to 80 phr, about 5 to about 60 phr, 5 to 60 phr, about 5 to about 50 phr, or 5 to 50 phr; in certain such embodiments, the at least one filler comprises at least one reinforcing filler. In certain embodiments of the first-fourth embodiments, the only filler(s) utilized in the rubber-containing liquid and/or present in the rubber-containing film is/are reinforcing filler(s). In certain embodiments of the first-fourth embodiments, the at least one filler comprises at least one of: carbon black, silica, calcium carbonate, or metal oxide(s) (e.g., zinc oxide, titanium oxide, magnesium oxide, aluminum oxide), with reinforcing grades of the foregoing being particularly preferred (e.g., N100, N200, N300, N400, N500 grades of carbon black). In certain embodiments of the first-fourth embodiments, the rubber-containing liquid and/or the rubber-containing film contains (further comprises) reinforcing carbon black filler in one of the foregoing amounts. In certain embodiments of the first embodiment, the at least one filler is added to the rubber-containing liquid as a dispersion (e.g., an aqueous dispersion) containing about 10% to about 50% by weight filler (based upon the total weight of the dispersion); in certain such embodiments, the at least one filler comprises carbon black and the dispersion is an aqueous dispersion of carbon black.

Other Ingredients

In certain embodiments of the first-fourth embodiments, the rubber-containing liquid and/or rubber-containing film contain (further comprise) one or more additional ingredients. Exemplary such ingredients include: stabilizers (e.g., non-ionic surfactants), plasticizers (e.g., petroleum oil(s), plant oil(s)), antioxidants, and combinations thereof. In certain embodiments of the first embodiment, at least one stabilizer, at least one antioxidant, or a combination thereof may be added as part of a rubber latex. The use of a stabilizer and/or antioxidant in the rubber-containing liquid may be particularly beneficial in those embodiments of the first embodiment wherein a majority by weight of the solvent comprises water. In certain embodiments of the first-fourth embodiments, the rubber-containing liquid and/or rubber-containing film comprises about 1 to about 10 phr (e.g., 1 phr, 2 phr, 3 phr, 4 phr, 5 phr, 6 phr, 7 phr, 8 phr, 9 phr, 10 phr), 1 to 10 phr, about 2 to about 8 phr, 2 to 8 phr, about 2 to about 6 phr, or 2 to 6 phr of at least one stabilizer. Exemplary surfactants for use in certain embodiments of the first-fourth embodiments include alkylene oxides (e.g., ethylene oxides, propylene oxides, and derivatives of either thereof such as with alcohols), alkyl phenol ethoxylates (e.g., polyethylene glycols, nonylphenol ethoxylates, fatty alcohol ethoxylates, polyethoxethylene esters of fatty acids (e.g., polyethoxyethylene (8) stearate, polyethoxyethylene (20) stearate, and polyethoxy (100) stearate), methyl ester ethoxylates, polyalkylene oxide block co-polymers, amine ethoxylates (e.g., triethanolamine), fatty alkanolamides (diethanolamide, diethanolamine, triethanolamine), amine oxides, esters of polyhydric alcohols and fatty acids, glycol esters, glycerol esters, polyglycerol esters, anhydrohexitol esters (e.g., sorbitan esters), polyoxyalkylene polyol esters (e.g., monoester laurate, monoester palmitate, monoester stearate, monoester oleate, trimester stearate, trimester oleate), alkyl poly glucosides, and combinations thereof. In certain embodiments of the first-fourth embodiments, the at least one stabilizer comprises at least one alkyl phenol ethoxylate. In certain embodiments of the first-fourth embodiments, the rubber-containing liquid and/or rubber-containing film comprises about 1 to about 5 phr (e.g., 1 phr, 2 phr, 3 phr, 4 phr, 5 phr), 1 to 5 phr, about 1 to about 3 phr, 1 to 3 phr, about 2 to about 5 phr, 2 to 5 phr of at least one plasticizer. In other embodiments of the first-fourth embodiments, the rubber-containing liquid and rubber-containing film are essentially free of any plasticizer (e.g., oil). By essentially free of any plasticizer is meant less than 5 phr, and in certain embodiments 1 phr or less, or even 0 phr. In certain embodiments of the first-fourth embodiments, the rubber-containing liquid and/or rubber-containing film comprises about 1 to about 10 phr (e.g., 1 phr, 2 phr, 3 phr, 4 phr, 5 phr, 6 phr, 7 phr, 8 phr, 9 phr, 10 phr), 1 to 10 phr, about 1 to about 5 phr, or 1 to 5 phr of at least one antioxidant.

In certain embodiments of the first-fourth embodiments, the rubber-containing liquid and/or rubber-containing film are substantially free or completely free of cure agents (e.g., sulfur) and vulcanization accelerators (e.g., DPG, MBTS, TBBS). By substantially free is meant less than 5 phr (in total) of cure agents and vulcanization accelerators, preferably less than 1 phr (in total) of cure agents and vulcanization accelerators, or less than 0.1 phr (in total) of cure agents and vulcanization accelerators. In other embodiments of the first-fourth embodiments, the rubber-containing liquid and/or rubber-containing film comprises (contains) a cure agent (e.g., sulfur) and at least one vulcanization accelerator. In certain embodiments of the first-fourth embodiments disclosed herein, the at least one vulcanization accelerator is selected from at least one of the following classes of vulcanization accelerators: thiurams, thioureas, dithiocarbamates, xanthates, or thiophosphates. In certain embodiments of the first-fourth embodiments, the at least one vulcanization accelerator comprises a thiazole, optionally in combination with one of more vulcanization accelerators from one or more of the foregoing classes. Non-limiting examples of vulcanizing accelerators that belong to the class of thiurams include: TMTM (tetramethyl thiuram monosulfide), TMTD (tetramethyl thiuram disulfide), DPTT (dipentamethylene thiuram tetrasulfide), TETD (tetraethyl thiuram disulfide), TiBTD (tetraisobutyl thiuram disulfide), and TBzTD (tetrabenzyl thiuram disulfide). Non-limiting examples of vulcanizing accelerators that belong to the class of thioureas include: ETU (ethylene thiourea), DPTU (N,N-diethyl thiourea), DETU (N,N-dibutylthiourea), and DBTU (diphenyl thiourea). Non-limiting examples of vulcanizing accelerators that belong to the class of dithiocarbamates include: ZDMC (zinc dimethyl dithiocarbamate), ZDEC (zinc diethyl dithiocarbamate), ZDBC (zinc dibutyl dithiocarbamate), ZEDC (zinc N-ethyl-dithiocarbamate), CDMC (copper dimethyl dithiocarbamate) and ZBEC (zinc dibenzyl dithiocarbamate). Non-limiting examples of vulcanizing accelerators that belong to the class of xanthates include: ZIX (zinc isopropyl xanthate). Non-limiting examples of vulcanizing accelerators that belong to the class of thiophosphates include: ZBDP (Zinc-O,O-di-N-phosphorodithioate). Non-limiting examples of vulcanizing accelerators that belong to the class of thiazoles include: MBT (2-mercaptobenzothiazole), MBTS (2,2-benzothiazole disulfide), ZMBT (zinc 2-mercaptobenzothiazole) and CMBT (copper 2-mercaptobenzothiazole). Additional examples of suitable vulcanizing accelerators for use in certain embodiments of the first-fourth embodiments disclosed herein include, but are not limited to, sulfonamides (e.g., N-cyclohexyl-2-benzothiazole-sulfenamide (CBS), N-tert-butyl-2-benzothiazole-sulfenamide (TBBS), and the like); guanidine vulcanization accelerators (e.g., diphenyl guanidine (DPG) and the like); and carbamate vulcanizing accelerators (e.g., zinc dibutyl dithocarbamate (ZDBC), zinc dibenzyl dithiocarbamate (ZBEC), zinc diethyl dithiocarbamate (ZDEC), zinc dimethyl dithiocarbamate (ZDMC), zinc N-ethyl-dithiocarbamate (ZEDC), copper dimethyl diothiocarbmate (CDMC), and the like), and combinations thereof; such vulcanization accelerators can be used either alone, in combination, or in combination with one of the foregoing classes of vulcanization accelerators. Generally, the total amount of vulcanization accelerator (when used) ranges from 0.5 to 15 phr (e.g., 0.5, 1, 2, 3, 4, 5, 6, 7, 8, 9, 10, 11, 12, 13, 14, 15 phr), 0.5 to 10 phr, 1 to 5 phr, or 2 to 10 phr. In certain embodiments of the first-fourth embodiments, the vulcanizing agent (when present) is used in an amount ranging from 0.1 to 10 phr (e.g., 0.1, 0.5, 1, 2, 3, 4, 5, 6, 7, 8, 9, 10 phr), including from 0.1 to 7.5 phr, including from 0.1 to 5 phr, and preferably from 0.1 to 3.5 phr.

### Allowing Liquid To Dry

As discussed above, according to the method of the first embodiment, after the lower surface of the cured inner liner is treated with the rubber-containing liquid, the liquid is allowed to dry upon the treated surface of the cured inner liner, thereby producing a rubber-containing film upon the dried, treated surface (i.e., upon the lower surface of the inner liner). According to the method of the first embodiment, the drying of the rubber-containing liquid upon the lower surface of the cured inner liner may employ various drying methods. According to certain embodiments of the first embodiment, the drying comprises at least one of: allowing the solvent(s) of the rubber-containing liquid to evaporate at room temperature; allowing the solvent(s) of the rubber-containing liquid to evaporate at a temperature above room temperature; circulating air (or a semi-inert or inert gas such as nitrogen or argon) that is at least one of room temperature, heated, or dehydrated over the treated surface of the cured inner liner; or subjecting the treated surface of the cured inner liner to a reduced pressure atmosphere. Preferably, the drying lasts 2 minutes or less. In certain embodiments, the drying lasts less than 60 seconds, even more preferably less than 30 seconds or less than 15 seconds before sufficient solvent is removed to produce the rubber-containing film. In those embodiments of the first embodiment wherein the rubber-containing liquid comprises a majority by weight of its solvent as water, the relatively longer drying times may be necessary, e.g., 2 minutes or less or 2 minutes to 60 seconds. In those embodiments of the second embodiment wherein the rubber-containing liquid comprises a majority by weight of its solvent as at least one hydrocarbon solvent, the relatively shorter drying times may be suitable, e.g., less than 60 seconds, less than 30 seconds or even less than 15 seconds.

### Rubber-Containing Film

As discussed above, according to the method of the first embodiment, a rubber-containing film is produced upon the lower surface of the cured inner liner, i.e., from drying of the rubber-containing liquid. The rubber (i.e., at least one conjugated diene monomer-containing rubber), as well as any filler, tackifier, stabilizer/surfactant, antioxidant, or plasticizer contained therein, will remain upon drying of the liquid or in other words will be present in the rubber-containing film. Accordingly, the above discussion of conjugated diene monomer-containing, filler, tackifier, stabilizer/surfactant, antioxidant and plasticizer (i.e., in the section entitled “Rubber-Containing Liquid”) should be understood to apply equally to the composition of the rubber-containing film as if fully set forth herein. As also discussed above, according first-fourth embodiments, the lower surface of the inner liner includes a rubber-containing film. The thickness of this rubber-containing film may vary. According to the third and fourth embodiments and certain embodiments of the first and second embodiments, the rubber-containing film has a thickness of about 0.1 to about 25 micrometers (e.g., 0.1 micrometer, 0.5 micrometers, 1 micrometer, 2 micrometers, 5 micrometers, 10 micrometers, 15 micrometers, 20 micrometers or 25 micrometers). In certain embodiments of the first-fourth embodiments, the rubber-containing film has a thickness of 0.1-15 micrometers, 0.5-15 micrometers, or 1-15 micrometers.

According to certain embodiments of the method of the first embodiment, the rubber-containing film that is produced upon the lower surface of the inner liner comprises a non-adhesive film. Similarly, in certain embodiments of the second-fourth embodiments, the rubber-containing film upon the lower surface of the cured inner liner comprises a non-adhesive film. A non-adhesive film is generally non-sticky to the touch (at room temperature). In certain embodiments of the first-fourth embodiments, a rubber-containing film that is non-adhesive may also be considered to be an adhesion film which increases the adherability of the lower surface of the cured inner liner. By adherability is meant the ability of other materials to adhere to the lower surface of the cured inner liner. Preferably, the non-adhesive film or adhesion film is capable of having a separate adhesive (e.g., a PSA) adhered to it. Notably, when the lower surface of the cured inner liner comprises a release treatment comprising polysiloxane moieties, prior to treatment with the rubber-containing liquid, the lower surface is not capable of having a separate adhesive (e.g., a PSA) adhere to it. Thus, the rubber-containing film produced by the method of the first embodiment disclosed herein as well as the rubber-containing film according to the second-fourth embodiments can be understood as improving the adherability of the lower surface of the cured inner liner (as compared to when the lower surface of the inner liner is merely treated with a release treatment comprising polysiloxane moieties).

According to the first-fourth embodiments, the rubber-containing film is on the lower surface of the cured inner liner. According to certain embodiments of the first-fourth embodiments, the rubber-containing film that is upon the lower surface of the cured inner liner can be understood as a coating upon the lower surface of the cured inner liner. Without being bound by theory, it is believed that the rubber-containing film is physically absorbed onto the lower surface of the inner liner. In those embodiments of the first-fourth embodiments wherein the rubber-containing liquid and/or rubber-containing film comprise a cure package, the rubber-containing film may covalently bond to the rubber within the lower surface of the cured inner liner.

### Treating The Lower Surface

As discussed above, according to the method of the first embodiment disclosed herein, the lower surface of the cured inner liner is treated with the rubber-containing liquid. The lower surface of the cured inner liner is the surface that will be positioned radially inward facing within a tire. According to the methods of the first embodiment, the treating may comprise various methods of applying the rubber-containing liquid to the lower surface of the cured inner liner. In certain embodiments of the first embodiment, the treating comprises at least one of: spraying, rolling, painting, dipping, or pouring the rubber-containing liquid onto the lower surface of the cured inner liner. The painting may comprise use of a brush or a foam applicator.

### Adhesive

As mentioned above, according to the fourth embodiment disclosed herein, the at least one radially inward component is adhered to the rubber-containing film upon the lower surface of the inner liner. In certain embodiments of the fourth embodiment, an adhesive is used to adhere the at least one radially inward component to the rubber-containing film of the lower surface of the inner liner. In certain embodiments of the fourth embodiment, the at least one radially inward component comprises a noise barrier (e.g., a foam noise barrier) and an adhesive is used to adhere the noise barrier to the rubber-containing film of the lower surface of the inner liner.

In certain embodiments of the fourth embodiment, the adhesive comprises a pressure sensitive adhesive (PSA); the pressure sensitive adhesive may be applied in various forms such as by coating (e.g., by dipping, rolling on, pressing on), extruding on, or by use of a PSA tape. Various materials may be used for the adhesive to adhere the noise barrier (or foam noise barrier) to the radially inner surface of the tire, and suitable adhesives, including suitable pressure sensitive adhesives, are known and commercially available. Generally, the adhesive should be compatible with the materials of the tire (e.g., the component to whose radially inner surface the noise barrier or foam noise barrier is adhered). In certain embodiments of the fourth embodiment, the adhesive comprises at least one of the following: (1) rubber (e.g., natural rubber, butyl rubber, halobutyl rubber, polybutadiene rubber, styrene-butadiene rubber, or a combination thereof), (2) acrylic polymer (e.g., an acrylate made by copolymerizing one or more acrylic ester with one or more other monomers or one of those discussed above), (3) silicone rubber, (4) polyether adhesive, (5) polyurethane polymer; in certain such embodiments, the adhesive is a PSA.

### Cured Tire

As discussed above, the fourth embodiment disclosed herein is directed to a cured tire comprising a tire body, a cured inner liner, and at least one component positioned radially inward of the cured inner liner. In certain embodiments of the fourth embodiment, the cured inner liner having a rubber-containing film upon its lower surface can be understood as resulting from a method according to the first embodiment. In certain embodiments of the fourth embodiment, the cured inner liner having a rubber-containing film upon its lower surface can be understood as being a cured inner liner according to the second or third embodiments.

In certain embodiments of the fourth embodiment, the cured tire further comprises at least one of: a tread, one or more body plies, a cap ply, or a sidewall. In certain embodiments of the fourth embodiment, the cured tire is a pneumatic tire. Generally, within a tire, a body ply is positioned radially inward of the tread and radially outward of the inner liner and comprises a layer comprising rubber-covered textile cords. In a tire comprising a pair of annular beads, the body ply is wrapped circumferentially around the tire and extends from bead to bead, in certain embodiments extending around the beads. In certain embodiments of the fourth embodiment, the tire comprises a body ply positioned radially outward of the inner liner; in certain such embodiments the body ply is adjacent to the inner liner with no intervening layer(s) between and in other such embodiments the body ply is separated from the inner liner by one or more intervening layers. In certain instances, the body ply is termed a carcass ply. A carcass ply is positioned radially inward of the tire tread and radially outward of the inner liner and also comprises a layer comprising rubber-covered textile cords; in certain tires of the fourth embodiment, one or more carcass plies are utilized and are positioned such that they extend from bead to bead in the tire with their respective cords positioned radially or diagonally (i.e., not circumferentially). When more than one carcass ply is utilized, each may be positioned such that their cord direction differs (e.g., biased to each other). Generally, within a tire, a cap ply is a layer that is positioned radially inward of the tread and radially outward of the inner liner, and also comprises rubber-covered textile cords. In certain embodiments of the fourth embodiment, the tire or cured tire comprises at least one belt ply positioned radially outward of a body ply and a cap ply positioned radially outward and circumferentially over all of a portion of the axial width of the belt ply or plies.

### Radially Inward Component

As discussed above, the fourth embodiment disclosed herein includes at least one component radially inward of the inner liner and the particular at least one component may vary. In certain embodiments of the fourth embodiment, the at least one component comprises: a noise barrier, an air barrier layer, a sealant layer, a run-flat insert, an electronic communication module, or a combination thereof. In certain embodiments of the fourth embodiment disclosed herein, the at least one component radially inward of the inner liner is adhered to but does not directly contact the film-containing lower surface of the cured inner liner. Generally, in such embodiments, an adhesive or other separate material may be located between the at least one component and the rubber-containing film upon the lower surface of the cured inner liner.

In certain embodiments of the fourth embodiment, the at least one component comprises a noise barrier; in certain such embodiments, the noise barrier comprises a foam noise barrier. The noise barrier or foam noise barrier (when present) may be made from various materials. Generally, a light-weight and low-density flexible material such as foamed rubber, foamed synthetic resin, or cellular plastic will be utilized for a foam noise barrier. According to the fourth embodiment, the foam noise barrier (when present) may comprise a foamed material (or spongy materials) that is either an open-cell type or a closed-cell type, although open-cell types are preferred. As non-limiting examples, the material of the foam noise barrier (when present) may comprise a synthetic resin foam such as ether based polyurethane foam, ester based polyurethane foam, polyethylene foam and the like; rubber foam such as chloroprene rubber foam, ethylene-propylene rubber foam, nitrile rubber foam, silicone rubber foam, or a combination thereof. In certain embodiments of the fourth embodiment, the foam noise barrier (when present) comprises polyethylene foam, polyurethane foam, or a combination thereof. When an adhesive is used to adhere the noise barrier (or foam noise barrier), that adhesive may be applied to the noise barrier (or foam noise barrier), to the radially inner surface of the tire (e.g., the inner liner or a body ply having a spray-on air barrier or sealant) to which the foam barrier (or foam noise barrier) will be adhered, or to both.

In certain embodiments of the fourth embodiment, the at least one component radially inner of the inner liner comprises a sealant layer, preferably without any adhesive layer between the sealant layer and the lower surface of the inner liner (i.e., the sealant layer directly contacts the lower surface of the inner liner). In certain embodiments of the fourth embodiment, the sealant is applied to the tire inner liner and functions to seal a puncture (e.g., from a nail) and prevent air from leaking from the tire (or at least slow the air leakage) after the puncture.

In certain embodiments of the fourth embodiment, the at least one component radially inner of the inner liner comprises an air barrier layer, preferably without any adhesive layer between the air barrier layer and the lower surface of the inner liner (i.e., the air barrier directly contacts the lower surface of the inner liner). In certain embodiments, the air barrier layer is applied as a spray-on material and functions to enhance the air impermeability of the inner liner, thereby better retaining air within a pneumatic tire.

In certain embodiments of the fourth embodiment, the at least one component radially inner of the inner liner comprises a run-flat insert. In certain such embodiments, the run-flat insert comprises a self-supporting run-flat insert such as may be used in the sidewall of a tire to produce a run-flat tire or self-supporting run-flat tire. A run-flat insert that is used in the sidewall of a tire may be positioned either axially inward or axially outward of the body ply. In certain embodiments of the fourth embodiment, the run-flat insert will comprise the radially innermost (or axially innermost) component in the sidewall portion of the tire; in certain such embodiments, the inner liner will comprise the radially innermost component in the remaining portion of the tire.

In certain embodiments of the fourth embodiment, the at least one component radially inner of the inner liner comprises an electronic communication module. In certain embodiments of the fourth embodiment, the electronic communication module comprises a radio device; in certain such embodiments, at least a portion of the outer surface of the radio device is surrounded by a rubber coating. As used herein, the term radio device should be understood to include any suitable radio device known in the art capable of storing information (i.e., data), communicating information, or both storing and communicating information with another device. In certain embodiments of the fourth embodiment, the radio device disclosed herein is capable of conveying information. The conveying of information by the radio device comprises the receipt of a radio signal combined with transponding (by reflecting) a portion of the received radio signal back to a reader with a signal modulated by varying the radio device's antenna impedance. Generally, such a radio device which conveys information by transponding in response to being activated by energy (e.g., electromagnetic waves) sent by an external, remote transponder (e.g., an interrogator-type or reader-type of transponder) is considered a passive device. In certain embodiments, the radio device disclosed herein is capable of actively transmitting information; such a radio device is an active device because it can actively transmit information. Certain such active devices transmit without the need for any activation by an external, remote transponder (e.g., at periodic intervals) and other such active devices actively transmit information in response to an appropriate activation received from an external, remote transponder. In certain embodiments of the fourth embodiment disclosed herein, the radio device conveys or transmits information via electromagnetic radio waves having a frequency in the range that is allowable according to local regulations. For example, in the United States, this frequency generally ranges from about 900 MHz to about 930 MHz (including 900 MHz to 930 MHz) (the current approved range being 902-928 MHz at a power level not to exceed 36 dbm) and in portions of Europe and Asia may be at a somewhat lower frequency of about 860 MHz (including 860 Mz) (the current approved range in portions of Europe is 865.6-867.6 MHz at a power level not to exceed 33 dBm). Generally, the radio devices discussed herein will be designed to convey or transmit information at a frequency ranging from about 860 MHz to about 960 MHz (including 860 MHz to 960 MHz). However, in certain embodiments of the fourth embodiment disclosed herein, the radio devices discussed herein may be designed to convey or transmit information at another frequency range. Examples of suitable radio devices for use with the electronic communication modules disclosed herein include transponders (e.g., devices that both receive information and transpond at least a portion of it), transmitters, receivers, and reflectors. Generally, the radio device is configured to convey or transmit information to/from an external, remote communication device, which itself may be a transponder, transmitter, receiver, or reflector depending on the functionality of the radio device of the electronic communication module of the fourth embodiment that it is communicating with (e.g., if the remote communication device is a transmitter, the electronic communication module's radio device is a transponder, receiver, or reflector capable of interacting with the electromagnetic waves sent from the transmitter). As used herein, the term “radio device” is inclusive of any and all of the components necessary to operate as a transponder, transmitter, receiver, or reflector, e.g., a circuit board, memory, antenna, etc.

In certain embodiments of the first-fourth embodiments, the rubber-containing film which is created or present upon the treated lower surface of the cured inner liner results in the ability to adhere at least one component (e.g., a foam noise barrier) to the inner liner. As discussed elsewhere herein, the adhering of the at least one component may be achieved using an adhesive such as a pressure-sensitive adhesive or a pressure-sensitive adhesive tape. In certain embodiments of the first-fourth embodiments, component is adhered to the inner liner via the rubber-containing film with sufficient adhesion to exhibit a peel strength of about 1 to about 20 N/mm (e.g., 1, 2, 3, 4, 5, 6, 7, 8, 9, 10, 11, 12, 13, 14, 15, 16, 17, 18, 19, or 20 N/mm), about 1 to about 19 N/mm, about 1 to about 18 N/mm, about 1 to about 17 N/mm, about 1 to about 16 N/mm, about 1 to about 15 N/mm, about 1 to about 14 N/mm, about 1 to about 13 N/mm, about 1 to about 12 N/mm, about 1 to about 11 N/mm, about 1 to about 10 N/mm, about 1 to about 9 N/mm, about 1 to about 8 N/mm, about 1 to about 7 N/mm, about 1 to about 6 N/mm, about 1 to about 5 N/mm, about 1 to about 4 N/mm, about 1 to about 3 N/mm, about 1 to about 2 N/mm, about 2 to about 20 N/mm, about 2 to about 19 N/mm, about 2 to about 18 N/mm, about 2 to about 17 N/mm, about 2 to about 16 N/mm, about 2 to about 15 N/mm, about 2 to about 14 N/mm, about 2 to about 13 N/mm, about 2 to about 12 N/mm, about 2 to about 11 N/mm, about 2 to about 10 N/mm, about 2 to about 9 N/mm, about 2 to about 8 N/mm, about 2 to about 7 N/mm, about 2 to about 6 N/mm, about 2 to about 5 N/mm, about 2 to about 4 N/mm, about 2 to about 3 N/mm, about 3 to about 20 N/mm, about 3 to about 19 N/mm, about 3 to about 18 N/mm, about 3 to about 17 N/mm, about 3 to about 16 N/mm, about 3 to about 15 N/mm, about 3 to about 14 N/mm, about 3 to about 13 N/mm, about 3 to about 12 N/mm, about 3 to about 11 N/mm, about 3 to about 10 N/mm, about 3 to about 9 N/mm, about 3 to about 8 N/mm, about 3 to about 7 N/mm, about 3 to about 6 N/mm, about 3 to about 5 N/mm, about 3 to about 4 N/mm, about 4 to about 20 N/mm, about 4 to about 19 N/mm, about 4 to about 18 N/mm, about 4 to about 17 N/mm, about 4 to about 16 N/mm, about 4 to about 15 N/mm, about 4 to about 14 N/mm, about 4 to about 13 N/mm, about 4 to about 12 N/mm, about 4 to about 11 N/mm, about 4 to about 10 N/mm, about 4 to about 9 N/mm, about 4 to about 8 N/mm, about 4 to about 7 N/mm, about 4 to about 6 N/mm, about 4 to about 5 N/mm, about 5 to about 20 N/mm, about 5 to about 19 N/mm, about 5 to about 18 N/mm, about 5 to about 17 N/mm, about 5 to about 16 N/mm, about 5 to about 15 N/mm, about 5 to about 14 N/mm, about 5 to about 13 N/mm, about 5 to about 12 N/mm, about 5 to about 11 N/mm, about 5 to about 10 N/mm, about 5 to about 9 N/mm, about 5 to about 8 N/mm, about 5 to about 7 N/mm, about 5 to about 6 N/mm, about 6 to about 20 N/mm, about 6 to about 19 N/mm, about 6 to about 18 N/mm, about 6 to about 17 N/mm, about 6 to about 16 N/mm, about 6 to about 15 N/mm, about 6 to about 14 N/mm, about 6 to about 13 N/mm, about 6 to about 12 N/mm, about 6 to about 11 N/mm, about 6 to about 10 N/mm, about 6 to about 9 N/mm, about 6 to about 8 N/mm, about 6 to about 7 N/mm, about 7 to about 20 N/mm, about 7 to about 19 N/mm, about 7 to about 18 N/mm, about 7 to about 17 N/mm, about 7 to about 16 N/mm, about 7 to about 15 N/mm, about 7 to about 14 N/mm, about 7 to about 13 N/mm, about 7 to about 12 N/mm, about 7 to about 11 N/mm, about 7 to about 10 N/mm, about 7 to about 9 N/mm, about 7 to about 8 N/mm, about 8 to about 20 N/mm, about 8 to about 19 N/mm, about 8 to about 18 N/mm, about 8 to about 17 N/mm, about 8 to about 16 N/mm, about 8 to about 15 N/mm, about 8 to about 14 N/mm, about 8 to about 13 N/mm, about 8 to about 12 N/mm, about 8 to about 11 N/mm, about 8 to about 10 N/mm, about 8 to about 9 N/mm, about 9 to about 20 N/mm, about 9 to about 19 N/mm, about 9 to about 18 N/mm, about 9 to about 17 N/mm, about 9 to about 16 N/mm, about 9 to about 15 N/mm, about 9 to about 14 N/mm, about 9 to about 13 N/mm, about 9 to about 12 N/mm, about 9 to about 11 N/mm, about 9 to about 10 N/mm, about 10 to about 20 N/mm, about 10 to about 19 N/mm, about 10 to about 18 N/mm, about 10 to about 17 N/mm, about 10 to about 16 N/mm, about 10 to about 15 N/mm, about 10 to about 14 N/mm, about 10 to about 13 N/mm, about 10 to about 12 N/mm, about 10 to about 11 N/mm, about 11 to about 20 N/mm, about 11 to about 19 N/mm, about 11 to about 18 N/mm, about 11 to about 17 N/mm, about 11 to about 16 N/mm, about 11 to about 15 N/mm, about 11 to about 14 N/mm, about 11 to about 13 N/mm, about 11 to about 12 N/mm, about 12 to about 20 N/mm, about 12 to about 19 N/mm, about 12 to about 18 N/mm, about 12 to about 17 N/mm, about 12 to about 16 N/mm, about 12 to about 15 N/mm, about 12 to about 14 N/mm, about 12 to about 13 N/mm, about 13 to about 20 N/mm, about 13 to about 19 N/mm, about 13 to about 18 N/mm, about 13 to about 17 N/mm, about 13 to about 16 N/mm, about 13 to about 15 N/mm, about 13 to about 14 N/mm, about 14 to about 20 N/mm, about 14 to about 19 N/mm, about 14 to about 18 N/mm, about 14 to about 17 N/mm, about 14 to about 16 N/mm, about 14 to about 15 N/mm, about 15 to about 20 N/mm, about 15 to about 19 N/mm, about 15 to about 18 N/mm, about 15 to about 17 N/mm, about 15 to about 16 N/mm, about 16 to about 20 N/mm, about 16 to about 19 N/mm, about 16 to about 18 N/mm, about 16 to about 17 N/mm, about 17 to about 20 N/mm, about 17 to about 19 N/mm, about 17 to about 18 N/mm, about 18 to about 20 N/mm, about 18 to about 19 N/mm, or about 19 to about 20 N/mm. In certain embodiments of the first-fourth embodiments, component is adhered to the inner liner via the rubber-containing film with sufficient adhesion to exhibit a peel strength of 1 to 20 N/mm (e.g., 1, 2, 3, 4, 5, 6, 7, 8, 9, 10, 11, 12, 13, 14, 15, 16, 17, 18, 19, or 20 N/mm), 1 to 19 N/mm, 1 to 18 N/mm, 1 to 17 N/mm, 1 to 16 N/mm, 1 to 15 N/mm, 1 to 14 N/mm, 1 to 13 N/mm, 1 to 12 N/mm, 1 to 11 N/mm, 1 to 10 N/mm, 1 to 9 N/mm, 1 to 8 N/mm, 1 to 7 N/mm, 1 to 6 N/mm, 1 to 5 N/mm, 1 to 4 N/mm, 1 to 3 N/mm, 1 to 2 N/mm, 2 to 20 N/mm, 2 to 19 N/mm, 2 to 18 N/mm, 2 to 17 N/mm, 2 to 16 N/mm, 2 to 15 N/mm, 2 to 14 N/mm, 2 to 13 N/mm, 2 to 12 N/mm, 2 to 11 N/mm, 2 to 10 N/mm, 2 to 9 N/mm, 2 to 8 N/mm, 2 to 7 N/mm, 2 to 6 N/mm, 2 to 5 N/mm, 2 to 4 N/mm, 2 to 3 N/mm, 3 to 20 N/mm, 3 to 19 N/mm, 3 to 18 N/mm, 3 to 17 N/mm, 3 to 16 N/mm, 3 to 15 N/mm, 3 to 14 N/mm, 3 to 13 N/mm, 3 to 12 N/mm, 3 to 11 N/mm, 3 to 10 N/mm, 3 to 9 N/mm, 3 to 8 N/mm, 3 to 7 N/mm, 3 to 6 N/mm, 3 to 5 N/mm, 3 to 4 N/mm, 4 to 20 N/mm, 4 to 19 N/mm, 4 to 18 N/mm, 4 to 17 N/mm, 4 to 16 N/mm, 4 to 15 N/mm, 4 to 14 N/mm, 4 to 13 N/mm, 4 to 12 N/mm, 4 to 11 N/mm, 4 to 10 N/mm, 4 to 9 N/mm, 4 to 8 N/mm, 4 to 7 N/mm, 4 to 6 N/mm, 4 to 5 N/mm, 5 to 20 N/mm, 5 to 19 N/mm, 5 to 18 N/mm, 5 to 17 N/mm, 5 to 16 N/mm, 5 to 15 N/mm, 5 to 14 N/mm, 5 to 13 N/mm, 5 to 12 N/mm, 5 to 11 N/mm, 5 to 10 N/mm, 5 to 9 N/mm, 5 to 8 N/mm, 5 to 7 N/mm, 5 to 6 N/mm, 6 to 20 N/mm, 6 to 19 N/mm, 6 to 18 N/mm, 6 to 17 N/mm, 6 to 16 N/mm, 6 to 15 N/mm, 6 to 14 N/mm, 6 to 13 N/mm, 6 to 12 N/mm, 6 to 11 N/mm, 6 to 10 N/mm, 6 to 9 N/mm, 6 to 8 N/mm, 6 to 7 N/mm, 7 to 20 N/mm, 7 to 19 N/mm, 7 to 18 N/mm, 7 to 17 N/mm, 7 to 16 N/mm, 7 to 15 N/mm, 7 to 14 N/mm, 7 to 13 N/mm, 7 to 12 N/mm, 7 to 11 N/mm, 7 to 10 N/mm, 7 to 9 N/mm, 7 to 8 N/mm, 8 to 20 N/mm, 8 to 19 N/mm, 8 to 18 N/mm, 8 to 17 N/mm, 8 to 16 N/mm, 8 to 15 N/mm, 8 to 14 N/mm, 8 to 13 N/mm, 8 to 12 N/mm, 8 to 11 N/mm, 8 to 10 N/mm, 8 to 9 N/mm, 9 to 20 N/mm, 9 to 19 N/mm, 9 to 18 N/mm, 9 to 17 N/mm, 9 to 16 N/mm, 9 to 15 N/mm, 9 to 14 N/mm, 9 to 13 N/mm, 9 to 12 N/mm, 9 to 11 N/mm, 9 to 10 N/mm, 10 to 20 N/mm, 10 to 19 N/mm, 10 to 18 N/mm, 10 to 17 N/mm, 10 to 16 N/mm, 10 to 15 N/mm, 10 to 14 N/mm, 10 to 13 N/mm, 10 to 12 N/mm, 10 to 11 N/mm, 11 to 20 N/mm, 11 to 19 N/mm, 11 to 18 N/mm, 11 to 17 N/mm, 11 to 16 N/mm, 11 to 15 N/mm, 11 to 14 N/mm, 11 to 13 N/mm, 11 to 12 N/mm, 12 to 20 N/mm, 12 to 19 N/mm, 12 to 18 N/mm, 12 to 17 N/mm, 12 to 16 N/mm, 12 to 15 N/mm, 12 to 14 N/mm, 12 to 13 N/mm, 13 to 20 N/mm, 13 to 19 N/mm, 13 to 18 N/mm, 13 to 17 N/mm, 13 to 16 N/mm, 13 to 15 N/mm, 13 to 14 N/mm, 14 to 20 N/mm, 14 to 19 N/mm, 14 to 18 N/mm, 14 to 17 N/mm, 14 to 16 N/mm, 14 to 15 N/mm, 15 to 20 N/mm, 15 to 19 N/mm, 15 to 18 N/mm, 15 to 17 N/mm, 15 to 16 N/mm, 16 to 20 N/mm, 16 to 19 N/mm, 16 to 18 N/mm, 16 to 17 N/mm, 17 to 20 N/mm, 17 to 19 N/mm, 17 to 18 N/mm, 18 to 20 N/mm, 18 to 19 N/mm, or 19 to 20 N/mm.

The foregoing peel strength numbers and ranges refer to measurements made at 23° C. The peel strength measurements can be made according to ASTM Procedure D903 and/or according to ASTM Procedure D1876 and utilizing a sample (e.g., from a tire or a partially assembled tire) containing an inner liner, a rubber-containing film, and a component such as a noise barrier adhered to the inner liner via the rubber-containing film. In certain embodiments, the foregoing peel strength numbers and ranges refer to measurements made using pressure sensitive adhesive or pressure sensitive tape to adhere the component to the inner liner via the rubber-containing film. When measuring peel strength, the measurement may be made upon a sample cut from an assembled component/adhesive/rubber-containing film/inner liner combination or may be prepared especially for testing (using the same ingredients for the inner liner, adhesive and rubber-containing film). When a sample is prepared especially for testing, the sample is preferably prepared adhering the component to the inner liner via the rubber-containing film. Alternatively, a sample may be prepared for testing using the same ingredients for the inner liner, adhesive and rubber-containing film but substituting a butyl rubber sheet for the component; using the foregoing type of sample may be especially useful when the product in question is manufactured or sold in a state that does not (yet) include an adhered component such as a foam noise barrier. The foregoing peel strength numbers and ranges are intended to refer to average numbers that can be obtained by averaging the result of three or four duplicate tests. When peel strength data is obtained in a form which separates measurements for peaks and valleys, the foregoing peel strength numbers and ranges refer to an average of the average peak and average valley measurement. In certain embodiments of the first-fourth embodiments, at least one of the average peak and average valley measurement falls within one of the foregoing ranges; in certain such embodiments, both the average peak and the average valley measurements fall within one of the foregoing ranges.

It will be understood by those within the art that, in general, terms used herein, and especially in the appended claims are generally intended as “open” terms. For example, the term “including” should be interpreted as “including but not limited to,” the term “having” should be interpreted as “having at least,” the term “includes” should be interpreted as “includes but is not limited to.” It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references, including but not limited to patents, patent applications, and non-patent literature are hereby incorporated by reference herein in their entirety.

While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

What is claimed is:

1-18. (canceled)

19. A method for treating a cured inner liner comprising:
a. providing a cured inner liner comprising rubber, a majority of which comprises butyl rubber (optionally halogenated), wherein the cured inner liner has an upper and a lower surface with the lower surface further comprising polysiloxane moieties,
b. treating the lower surface of the cured inner liner with a rubber-containing liquid wherein the rubber-containing liquid comprises at least one conjugated diene monomer-containing rubber and at least one solvent, and
c. allowing the rubber-containing liquid to dry upon the treated lower surface of the cured inner liner, thereby producing a rubber-containing film upon the lower surface.

20. The method of claim 19, wherein the rubber-containing film has a thickness of about 0.1 to about 25 micrometers.

21. The method of claim 19, wherein the rubber-containing liquid comprises about 10 to about 45% by weight of conjugated diene-monomer-containing rubber (based upon the total weight of the rubber-containing liquid).

22. The method of claim 19, wherein the treating comprises spraying.

23. The method of claim 19, wherein the rubber of the rubber-containing liquid comprises at least one of butyl rubber (optionally halogenated), natural rubber, polyisoprene, polybutadiene rubber, styrene-butadiene rubber, styrene-butadiene-isoprene rubber, isoprene-butadiene rubber, polychloroprene rubber, EPDM, or nitrile rubber.

24. The method of claim 19, wherein at least 80% by weight of the rubber in the rubber-containing liquid comprises a combination of butyl rubber, halogenated butyl rubber, and EPDM rubber.

25. The method of claim 19, wherein a majority by weight of the solvent present in the rubber-containing liquid comprises water.

26. The method of claim 19, wherein the rubber-containing liquid further comprises at least one tackifier.

27. The method of claim 25, wherein the rubber-containing liquid further comprises at least one: terpene, terpenoid, terpene derivative, or a combination thereof.

28. The method of claim 19, wherein a majority by weight of the solvent present in the rubber-containing liquid comprises at least one hydrocarbon solvent.

29. The method of claim 19, wherein a majority by weight of the solvent present in the rubber-containing liquid comprises one or more halogenated aromatic hydrocarbon solvents.

30. A treated, cured inner liner resulting from the method of claim 19.

31. A cured tire comprising
a cured inner liner comprising rubber, a majority of which comprises butyl rubber (optionally halogenated), wherein the cured inner liner has an upper surface and a lower surface with the lower surface positioned radially inward within the tire and the lower surface further comprises polysiloxane moieties and has a rubber-containing film thereupon, and
the rubber-containing film has a thickness of about 0.1 to about 25 micrometers and comprises at least one conjugated diene monomer-containing rubber.

32. The cured tire of claim 31, wherein the rubber-containing film comprises at least one of butyl rubber (optionally halogenated), natural rubber, polyisoprene, polybutadiene rubber, styrene-butadiene rubber, styrene-butadiene-isoprene rubber, isoprene-butadiene rubber, polychloroprene rubber, EPDM, or nitrile rubber

33. The cured tire of claim 31, wherein the rubber-containing film comprises a combination of butyl rubber, halogenated butyl rubber, and EPDM rubber.

34. The cured tire of claim 31, wherein the rubber-containing film further comprises at least one tackifier.

35. The cured tire of claim 31, wherein the rubber-containing film further comprises at least one terpene, terpenoid, terpene derivative, or a combination thereof.

36. A cured tire comprising a tire body, a cured inner liner, and at least one component positioned radially inward of the cured inner liner,
a cured inner liner comprising rubber, a majority of which comprises butyl rubber (optionally halogenated), wherein the cured inner liner has an upper surface and a lower surface with the lower surface positioned radially inward with the tire and the lower surface further comprises polysiloxane moieties and has a rubber-containing film thereupon,
the rubber-containing film has a thickness of about 0.1 to about 25 micrometers and
comprises at least one conjugated diene monomer-containing rubber, and
the at least one component positioned radially inward of the cured inner liner is adhered to the rubber-containing film of the lower surface of the inner liner.

37. The cured tire of claim 36, wherein the rubber-containing film comprises at least one of butyl rubber (optionally halogenated), natural rubber, polyisoprene, polybutadiene rubber, styrene-butadiene rubber, styrene-butadiene-isoprene rubber, isoprene-butadiene rubber, polychloroprene rubber, EPDM, or nitrile rubber

38. The cured tire of claim 36, wherein the rubber-containing film comprises a combination of butyl rubber, halogenated butyl rubber, and EPDM rubber.

39. The cured tire of claim 36, wherein the rubber-containing film further comprises at least one tackifier.

40. The cured tire of claim 36, wherein the rubber-containing film further comprises at least one terpene, terpenoid, terpene derivative, or a combination thereof.

41. The cured tire of claim 36, wherein the at least one component positioned radially inward of the cured inner liner is adhered using an adhesive comprising at least one of a pressure-sensitive adhesive or a pressure-sensitive adhesive tape.
